(19) United States
(12) Patent Application Publication
(10) Pub. No.: US 2005/0163103 A1
(43) Pub. Date: Jul. 28, 2005

(54) Connection admission control in packet-oriented, multi-service networks

(75) Inventors: Szabolcs Malomsoky, Szentendre (HU); Szilveszter Nadas, Mezotur (HU); Sandor Racz, Budapest (HU)

Correspondence Address: ERICSSON INC., 6300 LEGACY DRIVE, M/S EVR C11, PLANO, TX, 75024, US

(73) Assignee: Telefonakiebolaget LM Ericsson (publ), Stockholm (SE)

(21) Appl. No.: 10/507,249

(22) PCT Filed: Mar. 13, 2002
(86) PCT No.: PCT/SE02/00468

(51) Int. Cl. H04L 12/66

(52) U.S. Cl. 370/352; 370/395.2

(57) ABSTRACT

The present invention is generally based on the recognition that the true admissible regions for a multi-service traffic mix can be well approximated by a construction of a non-linear admissible region and one or more linear admissible regions. This makes it possible to accurately control admission of a new connection onto a transport link by checking whether the multi-service traffic mix defined by previously admitted connections together with the new connection is contained within an intersection on a non-linear admissible region and at least one linear admissible region, and admitting the connection if the traffic mix is contained within the intersecton of regions.

### TECHNICAL FIELD OF THE INVENTION

The present invention generally relates to connection admission control and more particularly to connection admission control in packet-oriented, multi-service networks with relatively strict delay and loss requirements.

### BACKGROUND OF THE INVENTION

Connection admission control (CAC) is generally a question of controlling the number of connections using a given set of resources in a communication network, thereby ensuring that admitted connections have access to the resources that are required to fulfil their Quality of Service (QoS) requirements. On the link level, CAC serves to restrict the number of connections simultaneously present on a transport link in the network. This means that new connections may be rejected in order to protect connections that are already admitted for transport over the link.

The issue of connection admission control in packet-oriented networks with limited transmission resources and relatively strict delay and loss requirements, such as higher generation radio access networks, is generally quite complex. With the introduction of multi-service networks, such as Universal Mobile Telecommunications System (UMTS) and similar communication networks, it becomes even more difficult to find an efficient CAC strategy that works in the multi-service environment and at the same time fulfils practical requirements such as limited computational complexity and high accuracy.

The practical requirements on the CAC algorithm mainly imply that the CAC decisions need to be taken fast, because hundreds or thousands of connections may arrive to a network node each second, and that the CAC algorithm has to make relatively accurate estimates of the resource requirements so that the CAC decisions are not too conservative, nor too optimistic.

In the prior art, connection admission control is fairly simple, based on the concept of effective bandwidths. This generally means that each individual connection is assigned a bandwidth value that represents the “effective” resource usage of the connection during its lifetime. When a new connection arrives to the node, the effective bandwidth of the connection is estimated based on factors such as the traffic characteristics and the QoS requirements. Subsequently, the CAC algorithm checks whether the sum of effective bandwidths of the admitted connections and the new connection exceeds the link capacity or not. The algorithm is so simple that the CAC decisions can be taken on-line. This approach thus satisfies the requirement on limited computational complexity.

Unfortunately, CAC based on effective bandwidths is generally not capable of ensuring that the QoS requirements in a multi-service traffic environment are actually fulfilled since the associated set or region of admissible traffic mixes with a single linear boundary is not a sufficiently accurate estimate of the true admissible region. The linear admissible region obtained from the effective-bandwidth algorithm is highly dependent on how well the assigned effective bandwidths represent the actual resource usage of the connections, and even a slight misestimation of the required resources may result in QoS degradations (underestimation) or a significant waste of valuable resources (overestimation).

### RELATED ART

A comparison of different connection admission control algorithms in ATM/AAL2 based third generation mobile access networks can be found in reference [1].

Reference [2] relates to a connection admission control strategy for ATM core switches and describes an effective-bandwidth algorithm for constant-bit-rate (CBR) connections as well as a connection admission control approach for variable-bit-rate (VBR) traffic. In the latter case, when statistically multiplexible VBR traffic (S-VBR) and non-statistically multiplexible VBR traffic (NS-VBR) are intermixed, the admissible region boundary is approximated by two piecewise linear segments corresponding to respective cell-loss-limited regions.

Reference [3] consider the problem of bounding the loss rates of the aggregation of ON-OFF sources in a bufferless model.

### SUMMARY OF THE INVENTION

The present invention overcomes these and other drawbacks of the prior art arrangements.

It is a general object of the present invention to provide an efficient connection admission control strategy for a multi-service traffic environment.

It is particularly important that the connection admission control is highly accurate, thus providing optimized resource utilization, while still ensuring that the QoS requirements of the entire multi-service traffic mix are met. It is thus an object of the invention to estimate the true admissible region as accurately as possible.

It is also an object of the invention to provide a computationally efficient connection admission control algorithm, thus allowing on-line decisions on the acceptance of new connections.

These and other objects are met by the invention as defined by the accompanying patent claims.

The present invention is generally based on the recognition that the true admissible region for a multi-service traffic mix can be well approximated by a construction of a non-linear admissible region and one or more linear admissible regions. This makes it possible to accurately control admission of a new connection onto a transport link by checking whether the multi-service traffic mix defined by previously admitted connections together with the new connection is contained within an intersection of the non-linear admissible region and the linear admissible region(s), and admitting the connection only if the traffic mix is contained within the intersection of regions.

By properly identifying the non-linear admissible region and the linear admissible region or regions according to the QoS requirements of the mixed services and the traffic characteristics, accurate decisions on the admittance of new connections can be taken to optimize the resource utilization while ensuring the QoS requirements.

In general, the admissible regions in the construction of the “true” admissible region are related to respective QoS requirements such as packet delay and overload (packet loss).

In radio access networks such as the Universal Terrestrial Radio Access Network (UTRAN), and especially on those links connecting base stations and radio network controllers, the use of delay-limited linear admissible regions in combination with an overload-limited non-linear admissible region has turned out to be particularly beneficial.

For improved performance and flexibility, each service class in the multi-service traffic mix is preferably associated with a class-specific delay-limited admissible region. Each class-specific delay-limited admissible region is normally defined as a linear admissible region that contains a set of traffic mixes that fulfil a given class-specific packet delay requirement.

Advantageously, the overload-limited non-linear admissible region contains the set of traffic mixes for which the probability of temporarily overloading the queuing system associated with the transport link is smaller than a given target value.

It has been validated that the linear approximation of the delay-limited admissible regions is very accurate. The linearity of these admissible regions means that the evaluation of whether a given traffic mix is contained within each of the delay-limited regions can be performed in a computationally efficient manner, because efficient single-class approximations can be extended to multiple service classes.

The non-linearity of the overload-limited admissible region generally implies that the probability of overload must be evaluated individually for each traffic mix. In many cases, this results in far too heavy calculations for on-line evaluation. However, by exploiting the so-called statistical gain within the different classes and not (or only partially) between classes, a much more computationally efficient algorithm is obtained.

In certain situations, it is not necessary to use both the linear and non-linear admissible regions. In fact, if the delay requirements are loose or the link capacities are large enough, it may be sufficient to check whether the traffic mix is contained within the non-linear admissible region. In other circumstances, it may be sufficient to use a construction of multiple linear admissible regions. In effect, the intersection of multiple linear admissible regions generally defines a non-linear region, which has a piecewise linear boundary.

The invention offers the following advantages:
High accuracy, leading to optimized resource utilization and maintained QoS for the entire multi-service traffic mix; and
Computational efficiency, allowing on-line decisions on the acceptance of new connections.

Other advantages offered by the present invention will be appreciated upon reading of the below description of the embodiments of the invention.

### BRIEF DESCRIPTION OF THE DRAWINGS

The invention, together with further objects and advantages thereof, will be best understood by reference to the following description taken together with the accompanying drawings, in which:

FIG. 1 illustrates the set of admissible traffic mixes of voice connections and 64 Kbps packet switched connections calculated using a conventional CAC algorithm, compared to the exact set of admissible mixes;

FIG. 2 is a schematic diagram illustrating an approximation of the true admissible region as a construction of a generally non-linear admissible region and one or more linear admissible regions according to a preferred embodiment of the invention;

FIG. 3 is a schematic diagram illustrating the basic architecture of a UMTS network;

FIG. 4 illustrates a typical probability density function of packet delay for a single service class;

FIG. 5 is a schematic diagram of an ATM/AAL2 based protocol stack of a UTRAN network;

FIG. 6 illustrates a network node fed by two ON-OFF connections;

FIG. 7 is a schematic diagram illustrating an example of an admissible region constructed as an intersection of two linear delay-limited regions and a non-linear overload-limited region;

FIG. 8 is a schematic flow chart of a method for connection admission control according to a preferred embodiment of the invention;

FIG. 9 is a schematic block diagram of pertinent parts of a network node in which a CAC algorithm according to the invention may be implemented;

FIG. 10A illustrates the admissible region in a first exemplary traffic environment with three service classes;

FIG. 10B illustrates a simulation of the delay violation probability for mixes on the surface of the admissible region of FIG. 10A;

FIG. 11A illustrates the admissible region obtained by the CAC of a preferred embodiment of the invention in a second exemplary traffic environment; and

FIG. 11B illustrates a simulation of the delay violation probability for mixes on the surface of the admissible region of FIG. 11A.

### DETAILED DESCRIPTION OF EMBODIMENTS OF THE INVENTION

Throughout the drawings, the same reference characters will be used for corresponding or similar elements.

In general, the task of the connection admission control (CAC) function in a network node is to decide whether a new connection that arrives to the node can be accepted for transport over a link of a given capacity such that the Quality of Service (QoS) requirements of the new connection and the already admitted connections are not violated. In order to ensure that the amount of resources is sufficient to serve the traffic demands, and at the same time ensure that expensive resources are not wasted, reliable CAC methods are needed.

For a better understanding of the invention it may be useful to begin by describing the basic concept of conventional CAC based on effective bandwidths in more detail. For example, the CAC algorithm currently in use in the transport and control platform Cello from Ericsson assigns an effective bandwidth to each connection, and simply estimates the resource usage of all connections as the sum of their effective bandwidths. In multi-service networks, connections can normally be grouped into service classes based on their traffic descriptors, and it is thus possible to assign an effective bandwidth to each service class. When a new connection arrives to the Cello node, the effective bandwidth of the connection is calculated by means of a simple exponential formula. Subsequently, the following inequality is checked:

$${\sum }_{i = 1}^{N} {EB}_{i} \leq C , \qquad ( 1 )$$

where N is the number of connections in the traffic mix defined by the admitted connections and the new connection, the EBᵢ values are the effective bandwidths of the connections and C is the link capacity. In this way, it can be determined whether the sum of the effective bandwidths of the traffic mix under consideration exceeds the link capacity or not. If the estimated resource usage of the traffic mix does not exceed the link capacity, the new connection is admitted for transport on the associated link, otherwise the connection request is rejected.

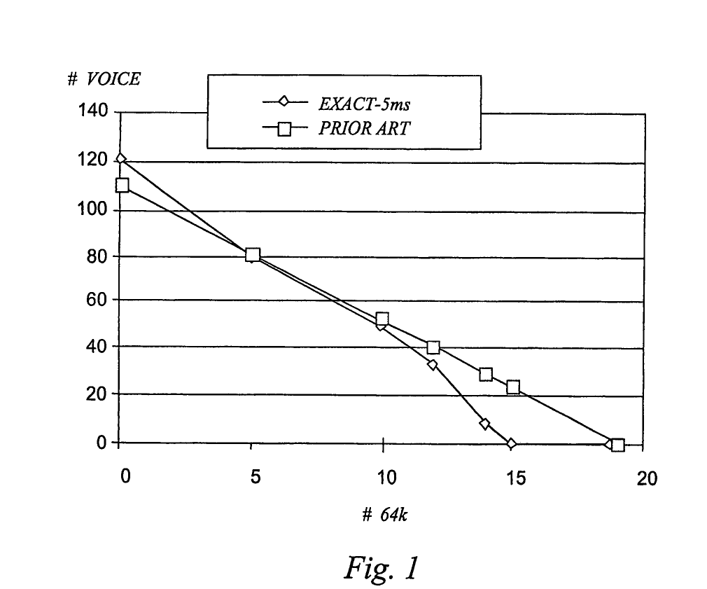

However, experiments reveal that conventional CAC algorithms based on effective bandwidths are generally not capable of ensuring that the QoS requirements in a multi-service traffic environment are actually fulfilled since the linear admissible region thus obtained is not a sufficiently accurate estimate of the true admissible region, as schematically illustrated in FIG. 1.

FIG. 1 illustrates the set of admissible traffic mixes of voice connections and 64 Kbps packet switched connections calculated using a conventional CAC algorithm, compared to the exact set of admissible mixes. The admissible region estimated in accordance with the conventional CAC algorithm has a single linear boundary, whereas the true (exact) admissible region is generally non-linear. The discrepancy between the estimated admissible region and the true admissible region leads to unreliable CAC decisions, with either too many or too few connections being admitted. Although the admissible regions illustrated in FIG. 1 may seem to be relatively close to each other, a slight underestimation of the required resources may result in serious QoS degradations since the delay may increase very rapidly at high loads.

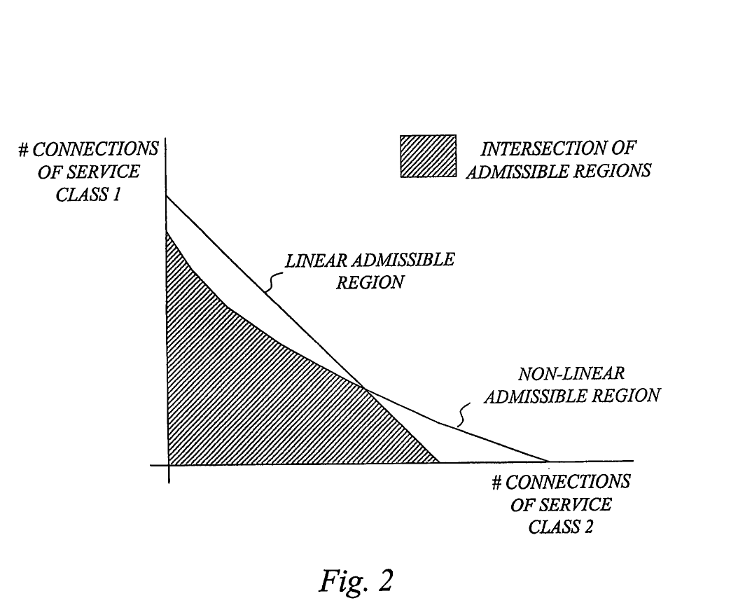

In contrast to the prior art, the invention preferably estimates the true admissible region by a construction of a generally non-linear admissible region and one or more linear admissible regions, as schematically illustrated for two service classes in FIG. 2. Mathematical evidence in combination with extensive simulations and experiments indicate that such a construction of non-linear and linear admissible regions is indeed a very good approximation of the true admissible region. This basic recognition makes it possible to accurately control admission of a new connection by checking whether a multi-service traffic mix defined by previously admitted connections together with the new connection is contained within an intersection of a generally non-linear admissible region and one or more linear admissible regions, and admitting the new connection only if the traffic mix is within the intersection of admissible regions.

An efficient CAC algorithm can be devised by properly identifying the non-linear admissible region and the linear admissible region or regions according to the QoS requirements of the mixed services and the traffic characteristics of the network under consideration. In this way, the resource utilization can be optimized while ensuring the QoS requirements.

In the following, the invention will mainly be described with respect to radio access networks such as the Universal Terrestrial Radio Access Network (UTRAN) in third generation mobile communication systems or other similar future communication systems.

With the introduction of third generation mobile systems, such as the Universal Mobile Telecommunications System (UMTS), both equipment vendors and network operators face new challenges. In contrast to second generation systems, a packet-switched, multi-service network capable of fulfilling the specific requirements of the new radio interface technology called Wideband Code Division Multiple Access (WCDMA) is required.

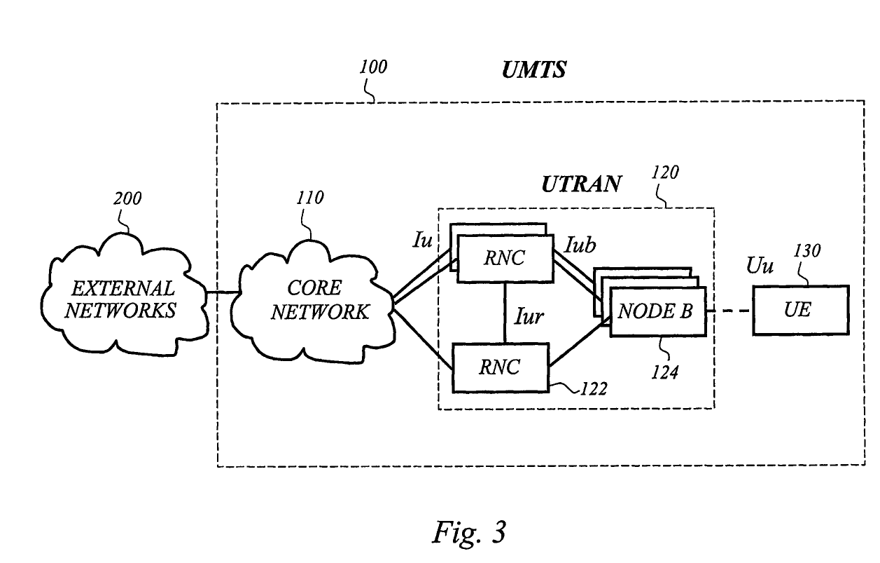

FIG. 3 is a schematic diagram illustrating the basic architecture of a UMTS network. The UMTS network 100 basically includes a core network 110, a Universal Terrestrial Radio Access Network (UTRAN) 120 and user equipment (UE) 130. The core network 110 is the backbone of UMTS connecting the access network 120 to external networks 200 such as the Public Switched Telephone Network (PSTN) and the Internet. The UTRAN network 120 handles all tasks related to radio access, and therefore UTRAN nodes are responsible for radio resource management, handover control, and so forth. The UTRAN network 120 is based on Radio Network Controllers (RNCs) 122 and base stations (Node Bs) 124. The user equipment 130 such as a mobile is connected to the Node B base stations 124 over the radio interface (Uu). A user terminal 130 can communicate with several Node Bs 124 at the same time during soft handover (which is an essential interference reduction technique in WCDMA systems). A Node B base station 124 is connected to an RNC 122 over the so-called Iub interface, whereas RNCs 122 are connected to each other over the so-called Iur interface. The RNCs 122 are connected to the core network 110 over the Iu interface.

Switching and multiplexing technologies used for the first releases of UTRAN for UMTS are based on Asynchronous Transfer Mode (ATM) in combination with the ATM Adaptation Layer type 2 (AAL2). Future releases will be deployed using also Internet Protocol (IP) technologies.

On transport links of UTRAN radio access networks, and especially on those links connecting base stations and radio network controllers, resource allocation is complex because the Quality of Service (QoS) requirements are quite strict and the amount of transmission resources is relatively low.

UMTS is a multi-service network, in which the various service classes generally have different QoS requirements. Packet delay is usually the most important performance measurement in the network, and for each service class, the delay budget for the whole system (end-to-end) determines the maximum acceptable delay in the UTRAN transport network. For example, the end-to-end maximum delay requirement for voice traffic is around 180 ms, and the maximum delay requirement in the UTRAN transport network is around 5-6 ms. The delay requirements for other services are not very different from that of voice. In case best effort services such as those provided in IP based networks, the delay requirements are relatively strict because the use of soft handover sets a practical limit on the packet delays. In addition, studies focusing on TCP performance show that the application-level throughput is significantly degraded if the delay on the Iub interface is larger than a few milliseconds.

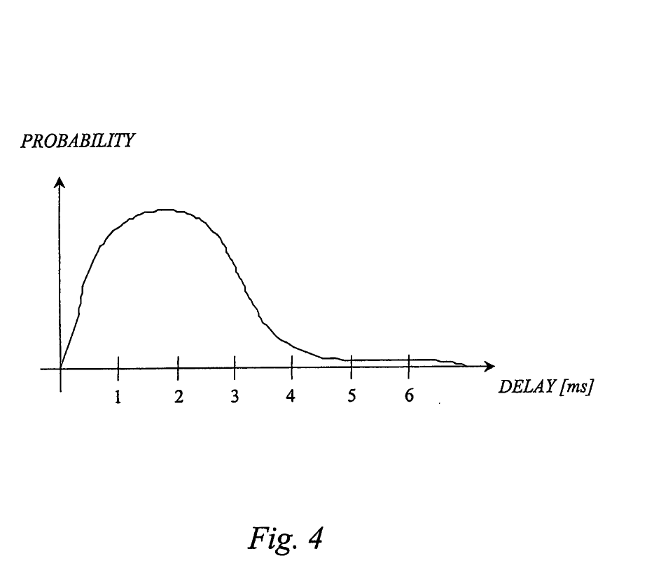

The delay requirement is typically defined in a probabilistic manner:
Pr(Dᵢ>\tilde{D}ᵢ)<\tilde{ε}ᵢ, (2)
where Dᵢ is the delay of a packet of class-i, \tilde{D}ᵢ is the maximum (target) delay for class-i, Pr(Dᵢ>\tilde{D}ᵢ) is the probability of packet delay criteria violation and \tilde{ε}ᵢ is a small target probability. A maximum delay of 5 ms and a target probability of 1% thus translates into the requirement that the probability of a delay larger than 5 ms should be smaller than 1%. FIG. 4 illustrates a typical probability density function of packet delay for a single service class, with the delay on the x-axis. The probability that the packet delay is larger than a given delay, say 5 ms, is represented by the tail area of the density function from the given delay.

The invention will now be described with respect to a particular example of a UTRAN network based on ATM/AAL2.

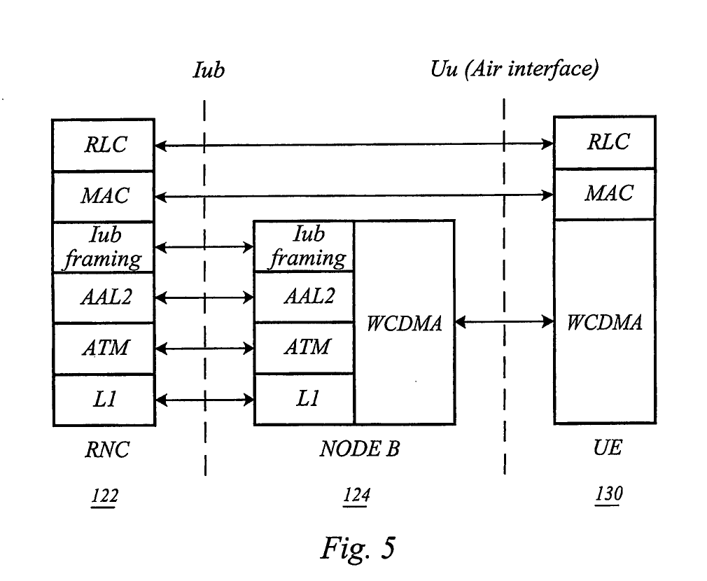

FIG. 5 is a schematic diagram of an ATM/AAL2 based protocol stack of a UTRAN network. The retransmission mechanism of the Radio Link Control (RLC) protocol ensures reliable transmission of loss-sensitive traffic over the radio interface. The Medium Access Control (MAC) protocol forms radio frames and schedules these periodically according to the timing requirements of WCDMA. This frame scheduling period is called TTI (Transmission Time Interval), and its length is typically a multiple of 10 ms. Bit rates of radio connections, so-called Radio Access Bearers (RABs) currently take typical values between 8 Kbps and 384 Kbps, keeping in mind that higher bit rates are feasible. MAC frame sizes and TTI lengths are typically RAB-specific. If the user equipment 130 has simultaneous RABs to two or more Node Bs 124 (during soft handover), the radio frames scheduled in downlink have to be sent out from every Node B 124 to the user equipment 130 at the same time (tₒᵤₜ). Therefore, nodes must generally be synchronized. For the same reason, it has to be ensured that each frame arrives to the Node Bs before tₒᵤₜ. This determines a delay requirement on the UTRAN transport network. On the Iub interface, the start positions of frames intended for different user terminals should not coincide in time in order to decrease the probability of packet congestions in the transmission network queues. Moreover, on the Uu interface, control patterns such as pilot bits should not be transmitted at the same time for all user terminals to avoid peaks in the interference. Therefore, phases of the periodic frame flows of different connections are randomly distributed over the Transmission Time Interval, as noted in reference [4].

The role of the UTRAN network is basically to transport MAC frames from the RNCs 122 to the Node Bs 124 (in the Iub downlink direction) and to transport MAC frames from Node Bs 124 to RNCs 122 (in the Iub uplink direction). In the UTRAN transport network, MAC frames are encapsulated into Iub frames. The Iub framing overhead contains information used in Node Bs 124 to encode the frame into the appropriate radio frame format and to send it out on the radio interface at the right time (tₒᵤₜ). Iub frames are segmented and packed into AAL2 CPS (Common Part Sublayer) packets, which are multiplexed into ATM cells. By AAL2 multiplexing, several AAL2 packets from different connections can be carried within an ATM cell. In an ATM network, cells are transported along a predefined path using the VPI/VCI (Virtual Path and Virtual Circuit Identifier) fields in the ATM header. The CID (Connection Identifier) field in the AAL2 header identifies a specific AAL2 connection within an ATM VC. the so-called CU timer (T_{CU}) determines how long the multiplexer should wait for arriving AAL2 packets if an ATM cell is partly filled. Therefore, multiplexing efficiency also depends on the value of T_{CU}, as realized in reference [5].

For admission control, we focus on situations when the transport links are highly loaded. In this region, the effect of T_{CU} on delay performance is expected to be negligible. It is also assumed that the packing density does not depend on the Iub frame size. These assumptions are supported by the analysis provided in reference [6]. In UTRAN, a new AAL2 connection is set up for each new RAB. In general, the AAL2 CAC allocates resources for the new AAL2 connections in the transport network, and makes CAC decisions based on traffic descriptors and QoS parameters.

At this stage, it will be useful to introduce an adequate queuing model for the UTRAN transport network, with specific emphasis on the Iub interface.

An Exemplary Queuing Model for the UTRAN Network

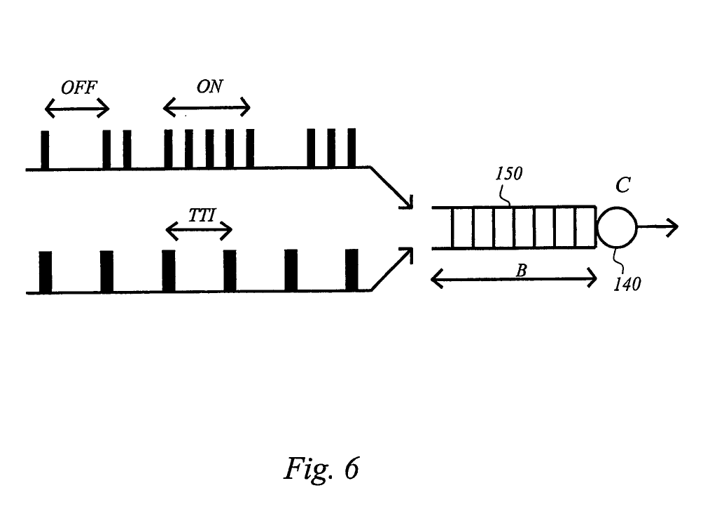

As discussed earlier, the arrival pattern of Iub frames is determined by the MAC scheduler, which schedules MAC frames periodically according to the timing requirements of WCDMA. In other words, the traffic is shaped by the MAC scheduler such that the lowest time-scale behavior is periodic irrespectively of the type of application. UTRAN traffic can thus be modeled as a superposition of periodic traffic sources. However, the carried traffic is generally not seen as a continuous periodic packet flow, but rather the user/application level traffic model is reflected in the UTRAN transport network such that the carried traffic is modeled by a series of active and inactive intervals. These intervals will be referred to as ON (active) and OFF (inactive) periods. FIG. 6 illustrates a network node fed by two ON-OFF connections. The network node comprises a packet server 140 with an associated output link capacity C and a queue 150 of length B fed by two periodic ON-OFF connections with different packet inter-arrival times (TTI) and packet sizes. In an ON period, MAC frames are sent in each period, while in an OFF period, packets are not sent at all. For example, in case of voice traffic the characteristics of the ON and OFF periods are determined by the interaction of the speech process (the speaker behavior) and the voice activity detector in the voice coder. The ON-OFF behavior, which originates from the user behavior, can be taken into account by an “activity factor”. The activity factor is the ratio of the ON intervals, defined as the average length of ON periods divided by the sum of the average lengths of ON and OFF periods. An activity factor can not be used to characterize a single connection. It can however be used to characterize all connections belonging to a certain service class in the system. In other words, the activity factor is a statistical measure describing the user/application behavior. If the activity factor is less than 1, then there is a potential for statistical multiplexing gain. For example, empirical measurements show that the activity factor for voice could be set to around 0.7.

It is desirable to establish a model, which allows us to derive the probability of packet delay requirement violation under the consideration of delays due to:
a the ON-OFF behavior, which results in temporary system overloads; and
the periodic packet emission during the ON (active) states, where the emission phases of different connections are uniformly distributed over the TTIs associated with the connections, which can result in packet congestions.

Assume that we have a system with the following input parameters:

| | |
|---|---|
| K | number of service classes |
| C | link capacity |
| Nᵢ | number of AAL2 connections (RABs) of class-i |
| αᵢ | activity factor of class-i |
| nᵢ | number of actually active connections of class-i |
| bᵢ | packet size (MAC frame with transport overhead) of class-i |
| TTIᵢ | packet inter-arrival time of class-i |
| \tilde{D}ᵢ | maximum delay (target delay) of class-i |
| \tilde{ε}ᵢ | target probability of delay requirement violation for class-i |

Input parameters (i = 1, . . . , K)

The total delay of a packet from service class-i includes two parts: Dᵢ=Wᵢ+Sᵢ, where Sᵢ is the service time and Wᵢ is the waiting time in the queue. The service time is the time taken by the packet server to service a packet and send it out of the buffer. For example, if the bit rate of the output link is 100 Kbps (kilobits per second) then the service time for a packet that is 100 bits long will be 1 ms. The delay of lost packets is considered to be infinite.

The workload (the amount of unfinished work) plays an important role in a multi-class queue analysis because in contrast with the per-class waiting time, workload is a global measure and allows us to calculate the per-class waiting times in case of a First-In-First-Out (FIFO) service discipline. In a FIFO queue the waiting time is approximated by the workload. The workload and accordingly the waiting time strongly depend on the lengths of the ON and OFF periods. If the system is in an overload situation in which the input rate R of active connections exceeds the link capacity C, the workload has an increasing component. When the overload situation ends, there will be a decreasing component.

In general, delays on a time-scale longer than the transmission time interval (TTI) have to be studied by examining the workload accumulated over several TTI periods. The accumulated workload is burst-length dependent and generally describes the component of the workload due to the ON-OFF behavior. The development of the accumulated workload depends on the random nature of the traffic sources, i.e. the distribution of the ON and OFF periods, the dependency among the traffic sources and so forth.

In UTRAN, the delay requirements are relatively strict, typically shorter than or of the same order as the TTI, and therefore we are generally interested in the short time-scale behavior of the workload. Besides, the signaled traffic descriptors directly available from the network do not include any characterization of burstiness thus gives no possibility to properly characterize the long time-scale behavior of the workload. It may be possible to measure the burst lengths. However, this is generally of little interest in the evaluation of the probability of delay requirement violation in UTRAN.

Before describing the actual model construction it will be useful to examine the impact of buffer size on the workload. Systems with large buffers can absorb the packets generated during overload situations, resulting in large waiting times without losses. On the other hand, a moderate size buffer (˜TTIₘₐₓ), where TTIₘₐₓ=max [TTIᵢ], is filled up quickly in an overload situation, and then packets suffer from at most a waiting time corresponding to the queue length or they get lost. The delay requirements in UTRAN are relatively strict (D˜TTI), which means that the waiting time reaches the predefined delay requirement very fast in an overload situation, and therefore the queue can not smooth out an overload situation efficiently even if considering infinite buffer lengths. We thus consider a system that can buffer packets at least the packet delay requirement but not significantly longer. It is furthermore assumed that in an overload situation, the delay of all packets is always larger than the delay requirement. Applying these assumptions we establish a combined model. Considering packets in the system, two types of delay requirement violation events can be observed:
some packets are lost due to buffer overflow; and
some packets are only exceeding their respective delay requirement.

The following relation expresses this decomposition:

$${ɛ}_{i} = \frac{\begin{matrix}number of lost packets + \\ number of delayed packets\end{matrix}}{number of packets} , \qquad ( 3 )$$

and we define two measures as:

$$\begin{matrix}{ɛ}_{i}^{lost} = \frac{number of lost packets}{number of packets} , & ( 4 ) \\ {ɛ}_{i}^{delayed} = \frac{number of delayed packets}{number of packets} . & ( 5 )\end{matrix}$$

Simulations and experiments show that the model assumptions are perfectly valid on the time-scale corresponding to the transmission time interval (TTI). In this region the delays hardly depend on the length of the ON periods, and delay violations are dominated by the periodic packet emission.

Now, we are in the position to determine the main relation between the input parameters and a relevant CAC decision. The stationary probability Π(n) of a particular number of active connections n=(n₁, n₂, . . . , n_{K}) is calculated using a multi-dimensional binomial distribution as follows:

$$Π ( \underline{n} ) = {\prod }_{i = 1}^{K} {Π}_{i} ( {n}_{i} ) = {\prod }_{i = 1} ( \begin{matrix}{N}_{i} \\ {n}_{i}\end{matrix} ) {{α}_{i}^{{n}_{i}} ( 1 - {α}_{i} )}^{{N}_{i} - {n}_{i}} . \qquad ( 6 )$$

From the model assumptions, it follows that packet loss probability can be well approximated by overload probability. The probability εᵢ^{lost} that a packet of class-i arrives at an overload situation (R>C) and gets lost, can thus be calculated as:

$${ɛ}_{i}^{lost} = \frac{{\sum }_{R ( \underline{n} ) > C} {n}_{i} Π ( \underline{n} )}{{\sum }_{∀ \underline{n}} {n}_{i} Π ( \underline{n} )} , \qquad ( 7 )$$

where R(n) represents the input rate of the active connections in a given state n.

In case of a normal situation (R≦C) the waiting time is dominated by the periodic packet emission, because the transient period (due to the change of the number of active sources when R≦C) is approximately TTIₘₐₓ long and hardly influences the waiting time. Therefore the probability of a packet arriving later than its delay criteria but not getting lost can be calculated as:

$$\begin{matrix}{ɛ}_{i}^{delayed} = \frac{{\sum }_{R ( \underline{n} ) \leq C} {n}_{i} Π ( \underline{n} ) \cdot Pr ( {D}_{i} > {\tilde{D}}_{i} \vert \underline{N} = \underline{n} )}{{\sum }_{∀ \underline{n}} {n}_{i} Π ( \underline{n} )} \\ = {\sum }_{R \underline{n} \leq C} {Π ( \underline{n} )}^{′} \cdot Pr ( {D}_{i} > {\tilde{D}}_{i} \vert \underline{N} = \underline{n} ) .\end{matrix} \qquad ( 8 )$$

Finally, the probability of delay criteria violation is the sum of the two probabilities as follows:
εᵢ=εᵢ^{lost}+εᵢ^{delayed}. (9)
An Exemplary CAC Algorithm for the UTRAN Network

When a new connection arrives, the CAC algorithm normally needs to check:
the delay violation due to packet loss (overload)
the delay violation due to delayed packets (delay)

In accordance with a preferred embodiment of the invention, the true admissible region is approximated by an intersection of K regions (also referred to as hyper-planes) with linear borders and a region with a generally non-linear border. The K regions with linear borders are delay-limited and referred to as delay-limited linear admissible regions. The i-th delay-limited linear region preferably contains the mixes where the delay requirement of the i-th traffic class is fulfilled. The region with a non-linear border is overload-limited and referred to as an overload-limited non-linear admissible region. The overload-limited non-linear region preferably contains the mixes for which the probability of temporarily overloading the queuing system is smaller than a given target value. If the activity factor of each class is 1, the overload-limited border becomes linear. In this case, it is the border of the mixes that do not overload the system.

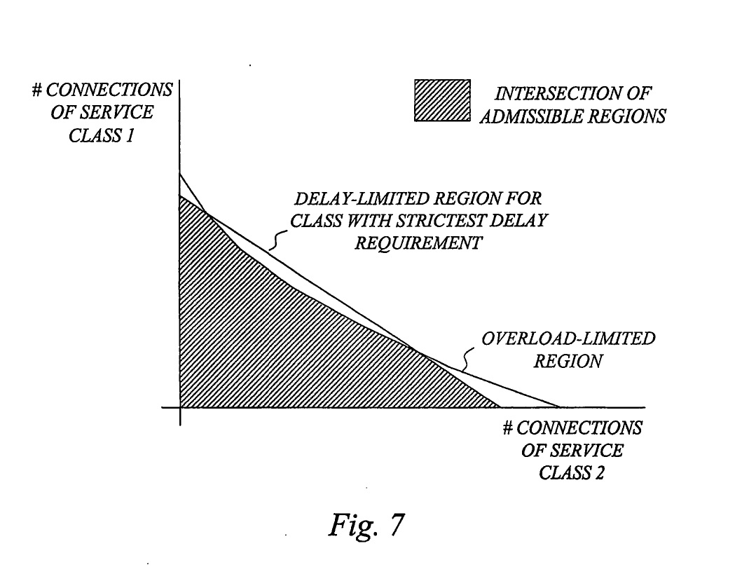

For example, assume that we have two service classes with different delay requirements. We are interested in the region where traffic mixes containing connections from both services can be accepted, and the admissible region is defined as the intersection of delay-limited and overload-limited regions, as illustrated in FIG. 7. One of the service classes has stricter delay requirements than the other class, and therefore only the strictest delay-limited region is considered. This delay-limited region contains the set of traffic mixes that fulfil a given packet delay requirement.

If the activity factors are equal to 1 for both service classes, the overload-limited region becomes linear and contains the mixes that do not overload the buffer. In practice, however, not all activity factors are equal to 1. This means that the overload-limited region generally will be non-linear, containing traffic mixes that can overload the queuing system only with a small probability. If the activity factor one or more of the service classes is smaller than 1 (which means the service is bursty on a time scale that is larger than its TTI), the overload-limited region generally becomes concave as schematically illustrated in FIG. 7.

The linear approximation of the delay-limited admissible regions is very accurate and means that the evaluation of whether a given traffic mix is contained within each of the delay-limited regions can be performed in a computationally efficient manner.

The non-linearity of the overload-limited admissible region generally implies that the probability of overload must be evaluated individually for each traffic mix.

Checking the Delay Violation Due to Packet Loss—the Overload-Limited Region

Although it is possible to use equation (7) to check the delay violation due to packet loss, the evaluation of equation (7) may be too demanding for on-line use (depending on the available processing resources). By exploiting the so-called statistical gain only within different classes and not between classes, a much more computationally efficient algorithm is obtained. Therefore, the following preferred strategy of the invention is proposed. Keeping in mind that loss probability and overload probability are more or less interchangeable according to the model assumptions, an upper bound for the target loss probability \tilde{ε}ᵢ^{lost} is derived:

$$\begin{matrix}1 - {\tilde{ɛ}}_{i}^{lost} = \frac{{\sum }_{R \underline{n} \leq C} {n}_{i} {\prod }_{k = 1}^{K} {Π}_{k} ( {n}_{k} )}{{\sum }_{∀ \underline{n}} {n}_{i} Π ( \underline{n} )} & ( 10 ) \\ 1 - {\tilde{ɛ}}_{i}^{lost} \geq \frac{{\sum }_{{n}_{1} = 0}^{{A}_{1}} {\sum }_{{n}_{2} = 0}^{{A}_{2}} … {\sum }_{{n}_{K} = 0}^{{A}_{K}} {n}_{i} {Π}_{1} ( {n}_{1} ) {Π}_{2} ( {n}_{2} ) … {Π}_{K} ( {n}_{K} ) }{{\sum }_{∀ \underline{n}} {n}_{i} Π ( \underline{n} )} , & ( 11 ) \\ 1 - {\tilde{ɛ}}_{i}^{lost} \geq \frac{\begin{matrix}{\sum }_{{n}_{1} = 0}^{{A}_{1}} {Π}_{1} ( {n}_{1} ) \cdot \\ {\sum }_{{n}_{2} = 0}^{{A}_{2}} {Π}_{2} ( {n}_{2} ) … {\sum }_{{n}_{i} = 0}^{{A}_{i}} {Π}_{i} ( {n}_{i} ) … {\sum }_{{n}_{K} = 0}^{{A}_{K}} {Π}_{K} ( {n}_{K} )\end{matrix}}{{\sum }_{{n}_{i} = 0}^{{N}_{i}} {n}_{i} {Π}_{i} ( {n}_{i} )} , & ( 12 ) \\ 1 - {\tilde{ɛ}}_{i}^{lost} \geq \frac{{\sum }_{{n}_{i} = 0}^{{A}_{i}} {n}_{i} {Π}_{i} ( {n}_{i} )}{{N}_{i} {α}_{i}} \cdot {\prod }_{l \neq i} ( {\sum }_{{n}_{l} = 0}^{{A}_{l}} {Π}_{l} ( {n}_{l} ) ) , & ( 13 )\end{matrix}$$

where we introduce Aᵢ as a per-class limit on the number of simultaneously active connections in ON state. Preferably, the per-class limit Aᵢ is defined as the number of connections from class-i such that the probability that more than Aᵢ connections from class-i are active at the same time is small. The idea is to “distribute” the probability 1−\tilde{ε}ᵢ^{lost} over the terms on the right hand side of the last inequality and to find minimal values of Aᵢ such that the following sets of inequalities:

$$\begin{matrix}\sqrt[{K}_{a}]{1 - {\tilde{ɛ}}_{i}^{lost}} \geq \frac{{\sum }_{{n}_{i} = 0}^{{A}_{i}} {n}_{i} {Π}_{i} ( {n}_{i} )}{{N}_{i} {α}_{i}} , & ( 14 ) \\ \sqrt[{K}_{a}]{1 - {\tilde{ɛ}}_{i}^{lost}} \geq {\sum }_{{n}_{l} = 0}^{{A}_{l}} {Π}_{l} ( {n}_{l} ) l = 1 , 2 , … , {K}_{a} , l \neq i , & ( 15 )\end{matrix}$$

are fulfilled, where K_{α} is the number of classes with activity factor αᵢ<1 and \tilde{ε}ᵢ^{lost} is the target probability assigned to class-i. For traffic classes with α=1, Aᵢ=Nᵢ. This construction makes it possible to compute Aᵢ values independently of each other, thus significantly reducing the computational complexity of equation (7). With enough memory for the CAC algorithm, one may wish to obtain the Aᵢ values from tables calculated off-line, as will be described in more detail later on.

Using the per-class limits (A₁, A₂, . . . , A_{K}), the necessary condition for accepting a given traffic mix (N₁, N₂, . . . , N_{K}) is defined as:

$${\sum }_{i = 1}^{K} {A}_{i} {ρ}_{i} \leq C , \qquad ( 16 )$$

where ρᵢ is the average load generated by one active traffic source from class-i and defined as ρᵢ=bᵢ/TTIᵢ. The evaluation of the inequalities (16) generally corresponds to the evaluation of whether the traffic mix is contained within the non-linear overload-limited region.

The statistical gains between classes can at least partially be taken into account by extending the basic algorithm in the following manner. It is clear that by using equations (14) and (15), only the statistical gain of multiplexing sources from the same class will be exploited. Keeping the property that Aᵢ values can be obtained independently from each other, but taking into account partially statistical gains from multiplexing different classes one may proceed as follows:

1. Find Aᵢ* for all i using eq. (14) with:

$${N}_{i}^{*} = {N}_{i} + {\sum }_{{α}_{k} \leq {α}_{i} , k \neq i} min ( 1 , \frac{ρ k}{ρ i} ) {N}_{k} ; k = 1 , … , K , \qquad ( 17 )$$

and calculate the statistical multiplexing gain for class-i as:

$${MG}_{i} = \frac{( {N}_{i}^{*} - {A}_{i}^{*} )}{{N}_{i}^{*}} . \qquad ( 18 )$$

2. Repeat the following procedure until the MGᵢ values are no longer increasing:
Consider the classes with αₖ>αᵢ and ρₖ<ρᵢ, ∀ i, k. If MGₖ>MGᵢ, then let αᵢ′:=αₖ and calculate MGᵢ′ as described in step 1. If MGᵢ′>MGᵢ, then let MGᵢ:=MGᵢ′. (19-A)
Consider the classes with αₖ>αᵢ and ρₖ≧ρᵢ, ∀ i, k. If MGₖ>MG, then let MGᵢ:=MGₖ. (19-B)

3. Finally, the Aᵢ values are found as:
Aᵢ=Nᵢ(1−MGᵢ). (20)
Checking the Delay Violation Due to Delayed Packets—the Delay-Limited Regions

There is no exact formula for evaluating the delay violation due to delayed packets, as recognized in reference [7]. We define the admissible region for checking the delay violation due to delayed (but not lost) packets by K hyper-planes. The i-th hyper-plane defines the region where the probability of a packet arriving later than its delay criteria but not getting lost is equal to or smaller than a given target probability, εᵢ^{delayed}≦\tilde{ε}ᵢ^{delayed}. This means that each class-specific packet delay requirement requires that the probability of the class-specific packet delay being larger than a given class-specific maximum delay is smaller than a given target value. We propose a method for hyper-plane construction that uses only a single-class calculation for evaluating the corresponding delay violation. For this purpose, the following two measures are introduced:
TNᵢⱼ is the maximum number of connections from class-i assuming that a single packet from class-j would fulfil the packet delay requirements of class-j. We preferably approximate by TNᵢⱼ the maximum number of connections from class-i if one additional connection from class-j is present in the system; and
TEᵢⱼ is a service class equivalent measure representing how many new connections that can be admitted from class-j in place of a connection from class-i considering only the packet delay requirement of class-j. For example, consider two service classes I and J. Imagine that there are 10 class-I connections and 20 class-J connections in the system. In this configuration, assume that 1% of the class-J packets are delayed more than 5 ms, and that this means that the delay requirement of class-J connections is just met. Take out one class-I connection from the system. In this case, the 1% percentile delay of class-J connections decreases below 5 ms. Next, add new class-J connections to the system until the 1% percentile delay of class-J connections reaches 5 ms again. For example, if the resulting number of class-J connections is 24, then TE_{IJ}=4.

The analysis of a constant service-time queue fed by nᵢ homogeneous periodic (active) connections is mainly based on the results in reference [8], and the probability of packet delay criteria violation Pr(Dⱼ⁽ⁱ⁾>\tilde{D}ⱼ|nᵢ connections are active) is calculated in the following way:

$$Pr ( {D}_{j}^{( i )} > {\tilde{D}}_{j} \vert {n}_{i} connections are active ) = {\sum }_{{x}^{′ < / \leq {n}_{i}}} ( \begin{matrix}{n}_{i} \\ l\end{matrix} ) {( \frac{l - {x}^{′}}{{TTI}^{′}} )}^{1} {( 1 - \frac{l - {x}^{′}}{{TTI}^{′}} )}^{{n}_{i} - 1} \cdot \frac{{TTI}^{′} - {n}_{i} + {x}^{′}}{{TTI}^{′} - l + {x}^{′}} , \qquad ( 21 )$$

where Dⱼ⁽ⁱ⁾ denotes the delay of a packet from class-j assuming that the delay of the associated queue comes from only class-i connections, \tilde{D}ⱼ is the target delay criteria of packets from class-j, and the following additional measures are introduced:

$$\begin{matrix}{x}^{′} = ( {\tilde{D}}_{j} - \frac{{b}_{j}}{C} ) / TU , & ( 22 ) \\ {TTI}^{′} = {TTI}_{i} / TU , & ( 23 ) \\ TU = \frac{{b}_{i}}{C} . & ( 24 )\end{matrix}$$

The proposed formula for determining the TN matrix is:

$${TN}_{ij} = max \{ {N}_{i} \vert {\sum }_{{n}_{i} = 0}^{{N}_{i}} Π ( {n}_{i} ) Pr ( {D}_{j}^{( i )} > {\tilde{D}}_{j} \vert {n}_{i} connections are active ) \leq {\tilde{ɛ}}_{j}^{delayed} \} , \qquad ( 25 )$$

where the stability criteria is not needed, because it is included in the inequalities (16).

The TE matrix can be determined from the TN matrix as follows:
TEᵢⱼ=TNⱼⱼ/TNᵢⱼ. (26)

Using traffic class equivalents, the necessary condition of accepting a given traffic mix (N₁, N₂, . . . , N_{K} is defined as:

$${\sum }_{i = 1}^{K} {N}_{i} \cdot {TE}_{ij} \leq {TN}_{ij} + constant , j = 1 , 2 , … , K , \qquad ( 27 )$$

If we approximate by TNᵢⱼ the maximum number of connections from class-i if one additional connection from class-j is present in the system, as proposed above, the constant should be set to 1. Using a fixed constant equal to 1 has proved to be important in the case of priority scheduling (as discussed later on), but can be used for FIFO scheduling as well. In a more conservative approach, the constant is set to zero, assuming that we approximate by TNᵢⱼ the maximum number of connections from class-i if no additional connection from class-j is present in the system.

The evaluation of the inequalities (27) corresponds to the evaluation of whether the traffic mix is contained within each of the linear delay-limited regions.

Alternatively, the probability of packet delay criteria violation can be approximated by the following expression for the class-specific complementary distribution function Qᵢ(x) of the workload in a FIFO queue, using a Brownian bridge approximation [9, 10]:

$$\begin{matrix}{Q}_{i} ( x ) = exp \{ - \frac{2 Cx}{{TTI}_{i} {n}_{i} {ρ}_{i}^{2}} ( \frac{Cx}{{TTI}_{i}} + C - {n}_{i} {ρ}_{i} ) \} , & ( 28 ) \\ x = {\tilde{D}}_{j} - \frac{{b}_{j}}{C} . & ( 29 )\end{matrix}$$

Consequently, instead of using equations (21)-(24), the probability of packet delay criteria violation is now determined as:

$$\begin{matrix}Pr ( {D}_{j}^{( i )} > {\tilde{D}}_{j} \vert {n}_{i} connections are active ) = exp \{ - \frac{2 Cx}{{TTI}_{i} {n}_{i} {ρ}_{i}^{2}} ( \frac{Cx}{{TTI}_{i}} + C - {n}_{i} {ρ}_{i} ) \} , & ( 30 ) \\ x = {\tilde{D}}_{j} - \frac{{b}_{j}}{C} . & ( 31 )\end{matrix}$$

Compared to equations (21)-(24), equations (30) and (31) do not involve a lot of summations and therefore the probabilities of packet delay criteria violation can be calculated much faster. Once the probabilities of packet delay criteria violation has been calculated according to equations (30) and (31), the TN and TE matrices can be determined according to equations (25) and (26) and the inequalities (27) can be checked.

In yet another alternative embodiment of the invention, the following even faster approximation for determining the TN matrix is used:

$$\begin{matrix}{TN}_{ij} = ⌈ \frac{C + \frac{{Cxα}_{i}}{{TTI}_{i}}}{{α}_{i} {ρ}_{i} - \frac{{α}_{i} {ρ}_{i}^{2} {TTI}_{i} ln ( {\tilde{ɛ}}_{j}^{delayed} )}{2 x}} ⌉ , & ( 32 ) \\ x = {\tilde{D}}_{j} - \frac{{b}_{j}}{C} . & ( 33 )\end{matrix}$$

The TN matrix is thus determined according to equations (32) and (33), and the TE matrix is determined as usual according to equation (26). Once the TN and TE matrices are determined, the inequalities (27) may be checked.

Naturally, by using the above fast approximations, the accuracy will be slightly reduced. The trade-off between computational complexity and accuracy has to be carefully evaluated by the system designer for each particular application.

The introduced queuing model for ATM/AAL2 and the associated CAC calculations can be more or less directly applied also in IP based UTRAN networks provided that the IP networks are CAC-enabled. The above model and the related methodology are applicable irrespectively of the transport technology used by the network.

Flow Chart

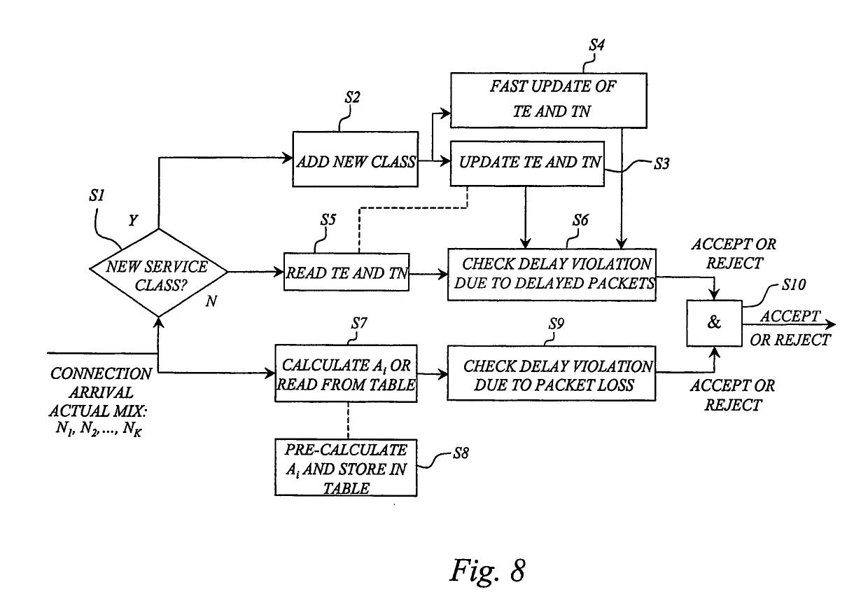

For a better overview of the CAC algorithm according to a preferred embodiment of the invention, reference is now made to the basic flow chart of FIG. 8. When a new connection arrives to a network node implementing the CAC algorithm according to the above preferred embodiment of the invention, it is determined (step S1) whether or not the connection belongs to a new service class based on signaled traffic descriptors.

It can be noted that since TNᵢⱼ and TEᵢⱼ depend only on the service classes present in the system, but not on the actual number of connections, these matrices are generally not necessary to calculate on-line. The TN and TE matrices are only updated when a new service class is added. Consequently, if the connection belongs to a new service class (Y) not yet included in the TN and TE matrices, the relevant traffic descriptors and QoS requirements of this service class are added (step S2) to the general information database used by the CAC algorithm and the TN and TE matrices are updated (step S3). This update can usually be performed rapidly without having to re-compute the whole matrices. However, if the normal TE and TN update proves to be too slow for on-line use, a fast update (step S4) of these matrices is required in order to be able to make a fast decision on the acceptance of the connection. Such a fast update may for example be based on peak bandwidths, or by using equations (32) and (33) above. On the other hand, if the connection belongs to a service class already present in the system (N), then the TN and TE matrices are read (step S5) and the delay violation due to delayed packets is checked (step S6) according to formula (27).

The Aᵢ values depend on Nᵢ, αᵢ, the target loss probabilities \tilde{ε}ᵢ^{lost} and the number K_{α} of traffic classes with activity factors αᵢ<1. The Aᵢ values can be calculated on-line (step S7), or if on-line calculation turns out to be too slow, tables with pre-calculated values can be constructed in advance (step S8) and subsequently accessed during on-line evaluation. At least some Aᵢ values can thus be pre-calculated for a range of different values of Nᵢ and/or αᵢ (\tilde{ε}ᵢ^{lost}), and stored in memory tables, as illustrated below.

Aᵢ tables for different values of N and α.

| | | | | |
|---|---|---|---|---|
| N | $A ( \sqrt{1 - {\tilde{ɛ}}_{i}^{lost}} )$ | $A ( \sqrt[2]{1 - {\tilde{ɛ}}_{i}^{lost}} )$ | . . . | $A ( \sqrt[{K}_{a}]{1 - {\tilde{ɛ}}_{i}^{lost}} )$ |

α = 0.1
1
2
.
.
.
N^{max}
α = 0.2
1
2
.
.
.
N^{max}

.
.
.

α = 0.9
1
2
.
.
.
N^{max}

This means that for a number of a values (e.g. 0.1, 0.2, . . . , 0.9), tables with Aᵢ values are stored, and for a certain [αᵢ, Nᵢ] pair, an Aᵢ value can be read from the corresponding table for a certain target probability. If the memory consumption is too high, only a certain window [1, 2, . . . , Nₘₐₓ] should be stored. This is normally sufficient, since the number of connections from a certain service class only changes in steps of one (+1: one connection arrives to the system, −1: one connection leaves the system). This means that the necessary window location and size can be tracked easily, and the tables can be updated whenever necessary. Other solutions using for example interpolation techniques can also be applied. Once the Aᵢ values are obtained, the delay violation due to packet loss is checked (step S9) according to formula (16).

Finally, the results of the two delay violation checks are combined (step S10) to produce a final CAC decision. In this particular embodiment of the invention, a given traffic mix is accepted only if both sets of inequalities (16) and (27) are fulfilled.

If the update and the decision making parts are carefully separated, the decisions can surely be made on-line even for large systems with many traffic classes. However, the update speed needs to be checked carefully, because it is possible that also the updates can be performed on-line.

Example of Implementation of an Admission Controller

Connection admission control is normally exercised over output link resources of network nodes, accepting or rejecting connections in accordance with a CAC algorithm. The CAC algorithm, may for example be implemented as hardware, software, firmware or any suitable combination thereof. In ATM networks, for example, traffic descriptors are signaled to the network nodes, and the nodes make decisions as to whether connections can be admitted based on the signaled information. In general, taking the network perspective, a connection is only admitted if it is accepted by all nodes taking part in the end-to-end transmission of that connection.

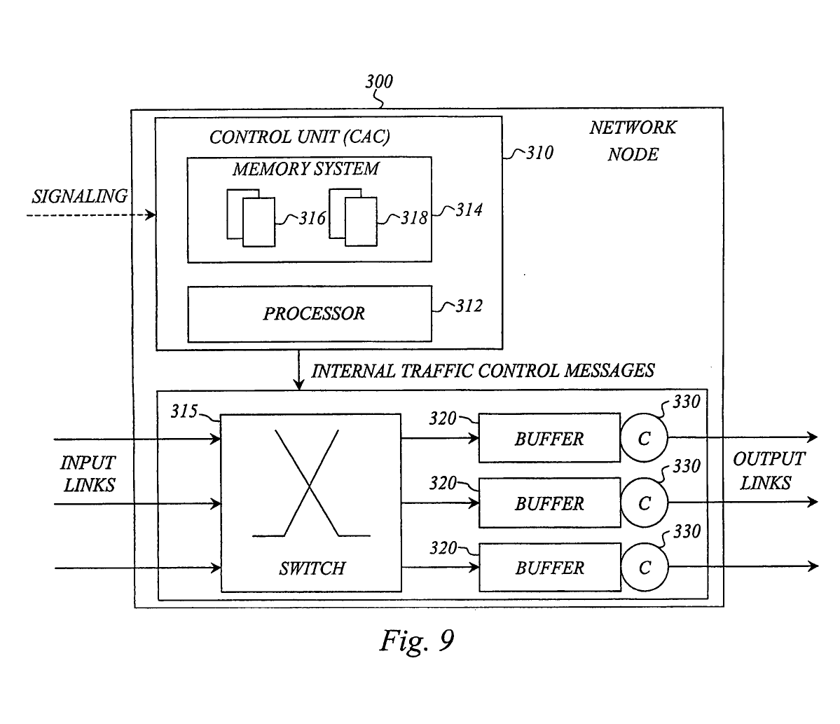

FIG. 9 is a schematic block diagram of pertinent parts of a network node in which a CAC algorithm according to the invention may be implemented. The network node 300 such as an RNC or a Node B is generally associated with a number of input links and output links. The node 300 preferably comprises a control unit 310, a switch fabric 315, a number of output buffers 320 and corresponding output servers 330. The control unit 310 is preferably built as a more or less embedded computer system with a processor 312 and associated memory system 314. The processor 312 may for example be a microprocessor or a digital signal processor. The CAC algorithm is preferably implemented as software executed by the control unit 310. The software may be written in almost any type of computer language, such as C, C++ or even specialized proprietary languages. In effect, the CAC algorithm is mapped into a software program, which when executed by the processor 312 produces CAC decisions in response to given QoS requirements and traffic information maintained in a special traffic information database 316 in the memory system 314. The traffic information is received from network traffic descriptors using for example classical signaling exchange mechanisms. Special look-up tables 318 for holding information used by the CAC algorithm may also be provided in the memory system 314. For each new connection set-up, the control unit 310 retrieves relevant information from the traffic information database and/or directly from the inter-node signaling, performs the necessary calculations and table look-ups and finally makes a CAC decision. The CAC decision is forwarded to the relevant protocol layers in the protocol stack to allow the decision to be effectuated. If a connection is rejected, a notification that the ATM/AAL2 or corresponding layer can not service the requested connection is sent up to the relevant protocol layers. If a connection is accepted, the connection is established and the corresponding packets are forwarded via the switch fabric 315 to the relevant buffer 320 for subsequent service by the corresponding output server 330. Internal traffic control messages from the control unit 310 generally controls packet switching and scheduling, and more particularly e.g. to which queue, if an admission decision is taken in a multi-queue system, the connection is directed. An example of a software implementation for execution by the control unit 310 is given in Appendix A.

Performance of the Proposed CAC

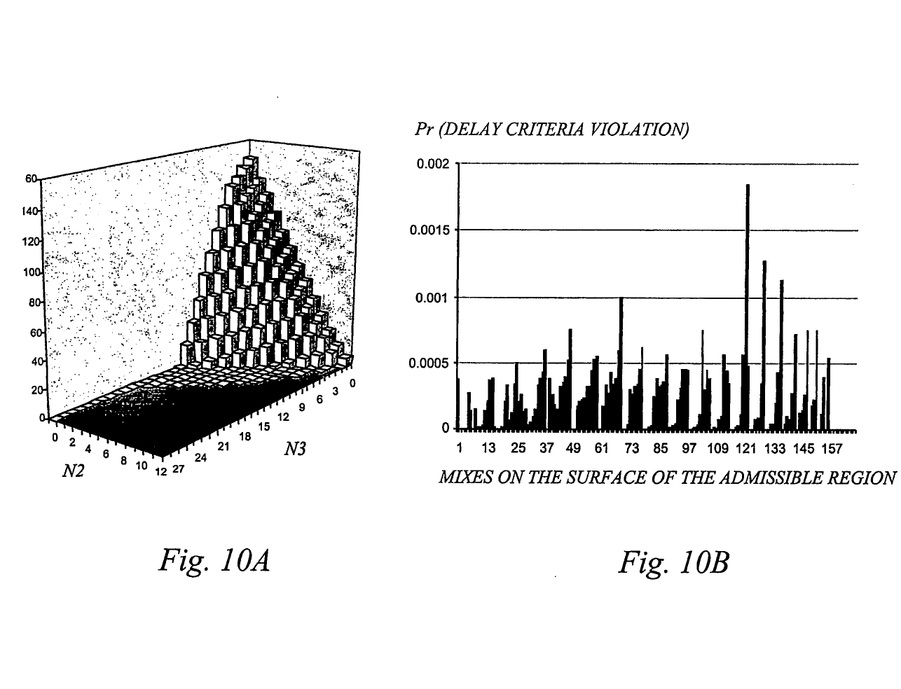

The performance of the invention has been evaluated in simulations. In a first simulation, the following input parameters were considered: C=1920 Kbps, TTI₁=20 ms, b₁=336 bits, α₁=0.65, TTI₂=10 ms, b₂=1512 bits, α₂=0.85, TTI₃=40 ms, b₃=2688 bits, α₃=1, \tilde{D}₁=5 ms, \tilde{D}₂=8 ms, \tilde{D}₃=20 ms, and \tilde{ε}=0.001. The admissible region obtained using the invention is illustrated in FIG. 10A. It can be seen that the borders of the admissible region are really hyper-planes. The surface covering the admissible region corresponds to those traffic mixes that just fulfil the QoS requirements, and for which a single extra connection would lead to a delay (or loss) violation.

The system with the traffic mixes on the surface was simulated to check if these mixes really fulfil the delay requirement. FIG. 10B illustrates the delay violation probability for the mixes on the surface of the admissible region of FIG. 10A. Identifiers of the different traffic mixes on the surface of the admissible region are given on the x-axis, and the probability of delay criteria violation is given on the y-axis. By way of example, traffic mix (N₁, N₂, N₃)=(3, 5, 6) has ID 45. For the purpose of examining the performance of the CAC, it is not important to tell which mix is associated with which ID. It can though be appreciated from FIG. 10B that the 0.001 limit is kept nicely for most of the mixes on the surface of the admissible region, implying that the CAC really works quite well.

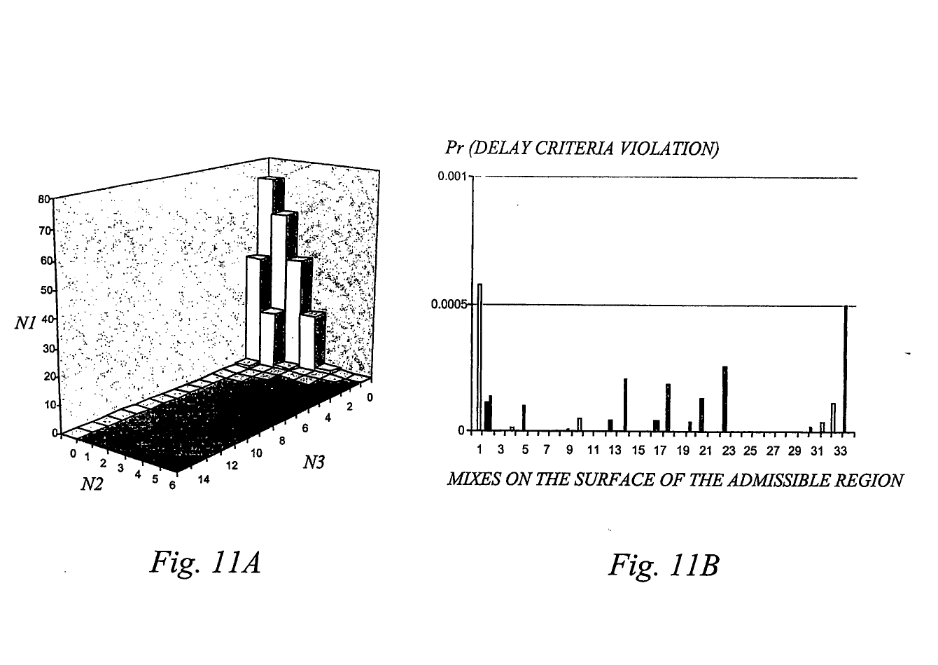

The example of FIGS. 11A-B generally corresponds to that of FIGS. 10A-B, but now with a smaller link capacity C=1024 Kbps. In case of smaller links, the calculation of the TN matrix as proposed by equation (25) tends to be more conservative. In this case, values of TN may be relatively small, and therefore the fact that the elements of TN are integers may constitute a problem. For example, TNᵢⱼ=4 may result in a significantly smaller admissible region than TNᵢⱼ=5. This problem may be solved by using any of a number of conventional interpolation techniques, allowing the elements of TN to take real values.

It is important to understand that the preceding description is merely intended to serve as a framework for an understanding of the invention.

In certain situations, it is not necessary to use both the linear and non-linear admissible regions. In fact, if the delay requirements are loose or the link capacities are large enough, it may be sufficient to check whether the traffic mix is contained within the non-linear admissible region. In other circumstances, it may be sufficient to use a construction of multiple linear admissible regions. In effect, the intersection of multiple linear admissible regions generally defines a non-linear region (which is piece-wise linear).

By properly identifying linear and non-linear admissible regions, the invention can also be applied to other transport mechanisms including natural extensions and developments of the basic UTRAN concept. For other types of multi-service networks, the non-linear admissible region and/or the linear admissible region or regions have to be identified according to the network-specific traffic characteristics and QoS requirements.

Notes on Use with Priority Scheduling

It should be noted that the traffic delay also depends on the scheduling principle applied in the network. If packets of all services wait in the same queue (FIFO) and the packets are served in order of arrival, the most stringent delay requirement has to be met. This can be avoided by service differentiation, having different queues for services with different delay requirements. The delay-limited linear regions are equivalent to “effective bandwidths” being assigned to connections. Effective bandwidths calculated for FIFO scheduling can be extended directly for priority scheduling as proposed in reference [11]. With respect to the invention, this means that instead of a single linear region for each service class with FIFO scheduling, there will generally be multiple linear regions for each service class, depending on the number priority levels.

Prioritization means that a packet from a lower priority queue can be served only if all the higher priority queues are empty. Segmentation is used to minimize the influence of large low priority packets already in the server on high priority traffic. The segment size s is an additional model parameter. Wᵢ and Sᵢ apply to the last segment instead of the whole packet. Wᵢ cannot be calculated directly using the work-load of the system because higher priority packets can over-take lower priority packets. Similarly to the FIFO case, the delay violation events are lost and delayed packets. When calculating εᵢ^{lost} and εᵢ^{delayed}, the only difference from the FIFO case is that from class-i point of view, the system is overloaded only if the input rate of traffic classes with higher (or equal) priority is higher than C.

We consider three cases depending on the priority levels of class-i and class-j. If class-i and class-j have the same priority level, then TNᵢⱼ is calculated in the same way as for FIFO scheduling set forth above. If class-i has higher priority we follow a different method. The event that the last segment (of size sₗₐₛₜ) of the class-j packet could not be served before time D is equivalent to the event that all segments before the last one could not be served before D′=D−sₗₐₛₜ/C. Formally, denote B⁽ⁱ⁾(0, t) the server availability in [0, t] seen by the class-j packet, if the higher priority traffic is given by class-i, when it has arrived at time 0, and then:

$$Pr ( {D}_{j}^{( i )} > {\tilde{D}}_{j} \vert {n}_{i} connections are active ) = Pr ( {B}^{( i )} ( 0 , {\tilde{D}}_{j} - \frac{{s}_{last}}{C} ) < \frac{{b}_{j} - {s}_{last}}{C} ) . \qquad ( 34 )$$

By using a conservative approximation of the server availability process: B⁽ⁱ⁾(0, t)≈t−Aᵢ(0, t)/C and the Brownian bridge approximation of the arrival process, the following formula is obtained:

$$Pr ( {D}_{j}^{( i )} > {\tilde{D}}_{j} \vert {n}_{i} connections are active ) \approx Φ ( {b}_{j} - {s}_{last} ; ( C - {N}_{i} {ρ}_{i} ) {D}^{′} , {N}_{i} {ρ}_{i}^{2} {D}^{′} ( {TTI}_{i} - {D}^{′} ) ) , \qquad ( 35 )$$

where Φ(x; μ, σ²) denotes the normal distribution. In order to demonstrate the accuracy of this approach, TNᵢⱼ values calculated using equation (35) are compared with exact values (C=920 Kbps, bᵢ=320 bits, sₗₐₛₜ=320 bits, TTIᵢ=20 ms, \tilde{D}=10 ms, \tilde{ε}ⱼ^{delayed}=0.1%) as illustrated below.

| | bⱼ [bits] | | | | | |
|---|---|---|---|---|---|---|
| | 320 | 640 | 960 | 1920 | 2880 | 3840 |
| TNᵢⱼ (exact) | 41 | 38 | 36 | 30 | 25 | 20 |
| TNᵢⱼ (approx.) | 37 | 36 | 34 | 29 | 24 | 20 |

If class-i has lower priority, the effect of a segment possibly under service from class-i on delays of class-j packets is neglected. This means that the TNᵢⱼ values are set to infinity (∞).

In general, simulations have shown that priority scheduling is more advantageous than FIFO scheduling and the effect of the service differentiation is that the QoS requirements can be met at higher resource utilization.

Notes on Use in the Multiple-Links Scenario

The CAC algorithms proposed by the invention method has mainly been presented and evaluated for the single link scenario. In the multiple-links scenario, the overall CAC decision is composed of more than one Link Admission Control (LAC) decision. In practice, a method working in the multiple-links scenario is usually identical to the single-link algorithm, because no information on the resources along the end-to-end path is available. If the proposed methods are applied in the multiple-links scenario, an “overload-limited” region can be computed for the different links individually. Single-link effective bandwidths can be extended to the network level, e.g. as proposed in reference [12]. Essentially, the “effective bandwidths” calculated by the invention do not change in other links of the network. This means that the proposed single-link methods can be applied to the multiple-links scenario without modifications.

The embodiments described above are merely given as examples, and it should be understood that the present invention is not limited thereto. Further modifications, changes and improvements which retain the basic underlying principles disclosed and claimed herein are within the scope and spirit of the invention.

### REFERENCES

[1] Comparison of Call Admission Control Algorithms in ATM/AAL2 Based 3rd Generation Mobile Access Networks by G. Fodor, G. Leijonhufvud, Sz. Malomsoky and A. Rácz, Proc. IEEE Wireless Communications and Networking Conference, 1999.
[2] Connection Admission Control Design for GlobeView-2000 ATM Core Switches by L. He and A. K. Wong, Bell Labs Technical Journal, pp. 94-110, January-March 1998.
[3] Bounding On-Off Sources—Variability Ordering and Majorization to the Rescue by A. M. Makowski, ISR TR 2001-13.
[4] 3GPP. Synchronisation in UTRAN (Stage 2), Technical Specification, TR 25.402 V4.1.0, June, 2001.
[5] Performance Evaluation and Dimensioning for AAL2 CLAD by H. Saito, Proc. IEEE INFOCOM, pp. 153-160, 1999.
[6] 3GPP. Delay Budget within the Access Stratum, Technical Report TR 25.853 V4.0.0, May, 2001.
[7] The Superposition of Variable Bit Rate Sources in an ATM Multiplexer by Ilkka Norros, James W. Roberts, Alain Simonian, and Jorma T. Virtamo, IEEE Journal on Selected Areas in Communications, Vol. 9, No. 3, pp. 378-387, 1991.
[8] Methods for the performance evaluation and design of broadband multiservice networks, Part III, Traffic models and queuing analysis, COST 242 Final Report, 1996.
[9] A Queue with Periodic Arrivals and Constant Service Rate, by B. Hayek, Probability, Statistics, and Optimisation, a Tribute to Peter Whittle, Wiley, pp. 147-157, 1994.
[10] Notes on Effective Bandwidths, by F. P. Kelly, Stochastic Networks: Theory and Applications, Vol. 4, Oxford University Press, pp. 141-168, 1996.
[11] Effective Bandwidths with Priorities by Arthur W. Berger and Ward Whitt, IEE/ACM Transactions on Networking, Vol. 6, No. 4, August 1998.

[12] The Output of a Switch, or Effective Bandwidths for Networks by Damon Wischik, Queuing Systems, Vol. 32, pp. 383-396, 1999.

APPENDIX A
An example of a software implementation

```
Global variables
  Capacity_kbps as Double
  nTTIs as Integer
  TTIs(1 To nTTIs) as Integer
  nClasses as Integer
  nClassesMax as Integer
  TETable(1 To nTTIs,1 To nClassesMax,1 To nClassesMax) as Double
  TNTable(1 To nTTIs,1 To nClassesMax) as Double
  NSourcesMax as Integer
  nActivities as Integer
  nActivitiesMax as Integer
  consideredActivities(1 To nActivitiesMax) as Double
  nMaxActive as Integer
  ActTable_1(1 To nActivitiesMax,
  1 To NSourcesMax, 1 To nMaxActive) as Integer
  ActTable_2(1 To nActivitiesMax,
  1 To NSourcesMax, 1 To nMaxActive) as Integer
  NSources(1 To nClassesMax) as Integer
  TTI_ms(1 To nClassesMax) as Double
  PacketSize_bit(1 To nClassesMax) as Double
  Activity(1 To nClassesMax) as Double
  Delay(1 To nClassesMax) as Double
  ActivityIndex(1 To nClassesMax) as Integer
  TTIIndexes(1 To nClassesMax) as Integer
  Loss as Double
  LossNDD as Double
  LossOnOff as Double
  nOnOffClasses as Integer
  TTIIndex as Integer
End Global variables
# ---------------------------------------------------------------------------------------
NewCall(_classIndex) As Boolean
  NSources(_classIndex) = NSources(_classIndex) + 1
  If NSources(_classIndex) = 1 Then
    ClassOn(_classIndex)
  End If
  Result=Admit( )
  If Result=FALSE Then
    NSources(_classIndex) = NSources(_classIndex) − 1
    If NSources(_classIndex) = 0 Then
      ClassOff(_classIndex)
    End If
  End If
  Return Result
End
# ---------------------------------------------------------------------------------------
EndCall(_classIndex)
  NSources(i)=NSources(i)−1
  If NSources(i)=0 Then
    ClassOff(_classIndex)
  End If
End
# -----------------------------------------------------------------------
Admit( )
  If AdmitNDD( )=FALSE Then
    Return FALSE
  Else
    Return AdmitOnOff( )
  End
End
# -----------------------------------------------------------------------
AdmitNDD( )
  For j = 1 To nClasses
    If NSources(j) > 0 Then
      Sum = 0
      For i = 1 To nClasses
        Sum = Sum + NSources(i) * TETable(TTIIndex, i, j)
      Next i
      If Sum > TNTable(TTIIndex, j)+1 Then
        Return FALSE
      End If
    End If
  Next j
  Return TRUE
End
# ---------------------------------------------------------------------------------------
AdmitOnOff( )
  For i=1 To nClasses
    sumBw=0
    For j=1 To nClasses
      If ActivityIndex(j)=−1 OR NSources(j)=0 Then
        A=NSources(j)
      Else If i=j Then
        A = ActTable_2(ActivityIndex(j),NSources(j),nOnOffClasses)
      Else
        A = ActTable_1(ActivityIndex(j),NSources(j),nOnOffClasses)
      End If
      sumBw=sumBw + A * PacketSize_bit(j) / TTI_ms(j)
    Next j
    If sumBw > Capacity_kbps Then
      Return FALSE
    End If
  Next i
  Return TRUE
End
# ---------------------------------------------------------------------------------------
ClassOn(_classIndex)
  If TTIIndexes(_classIndex) > TTIIndex Then
    TTIIndex=TTIIndexes(_classIndex)
  End If
  If Activity(_classIndex) < 1 Then
    nOnOffClasses = nOnOffClasses + 1
  End If
End
# ---------------------------------------------------------------------------------------
ClassOff(_classIndex)
  If TTIIndexes(_classIndex) = TTIIndex Then
    TTIIndex=1
    For i=1 To nClasses
      If NSources(i) > 0 AND TTIIndexes(i) > TTIIndex Then
        TTIIndex=TTIIndexes(i)
      End If
    Next i
  End If
  If Activity(_classIndex) < 1 Then
    nOnOffClasses = nOnOffClasses − 1
  End If
End
# ---------------------------------------------------------------------------------------
Init( )
    #set the following Values
  Capacity_kbps =
  nTTIs =
  TTIs( ) = #must be ordered
  nClassesMax=
  nActivitiesMax =
  nMaxActive =
  NSourcesMax =
  Loss=
    #defaults
  nClasses=0
  nActivities=0
  nOnOffClasses=0
  TTIIndex=1
    # can be different
  LossNDD=Loss/2
  LossOnOff=Loss−LossNDD
End
# ---------------------------------------------------------------------------------------
AddClassToTable(_TTI,_PacketSize,_Activity,_Delay)
  nClasses=nClasses+1 #not higher than nClassesMax
  classIndex=nClasses
  NSources(classIndex)=0
  TTI_ms(classIndex)=_TTI
  PacketSize_bit(classIndex)=_PacketSize
  Delay(classIndex)=_Delay
  Activity(classIndex)=_Activity
  If_Activity < 1 Then
    For i=1 To nActivities
      If consideredActivities(i)=_Activity Then
        Break
      End If
    Next i
    ActivityIndex(classIndex)=i
    If i>nActivities Then
      AddActivity(_Activity)
    End If
  Else
    ActivityIndex(classIndex)=−1
  End If
  For i=1 To nTTIs
    If TTIs(i)>=_TTI Then
      Break
    End If
  Next i
  TTIIndexes(classIndex)=min(i,nTTIs)
  SetTNs(classIndex)
  For j=1 To nClasses −1
    SetTEs(classIndex,j)
    SetTEs(j,classIndex)
  Next j
  SetTEs(classIndex,classIndex)
End
# ---------------------------------------------------------------------------------------
AddActivity(_activity)
  nActivities=nActivities+1 #not higher than nActivitiesMax
  index=nActivities
  consideredActivities(index)=_activity
  For i=1 To NSourcesMax
    For j=1 To nMaxActive
      ActTable_1(index,i,j)=N_OnOff(i,_activity,LossOnOff/j,1)
      ActTable_2(index,i,j)=N_OnOff(i,_activity,LossOnOff/j,2)
    Next j
  Next i
End
# ---------------------------------------------------------------------------------------
SetTNs(_classIndex)
  For i=TTIIndexes(_classIndex) To nTTIs
    TNTable(i,_classIndex) = CalcTN(_classIndex,_classIndex,TTIs(i))
    If PacketSize_bit(_classIndex) /
    Capacity_kbps < Delay(_classIndex) Then
        TNTable(i,_classIndex) = CAC_TNTable(i,_classIndex) + 1
    End If
  Next i
End
# ---------------------------------------------------------------------------------------
SetTEs(_i,_j)
  For i=max(TTIIndexes(_i),TTIIndexes(_j)) To nTTIs
    If _i=_j Then
      TETable(i,_i,_j) = 1
    Else
      TETable(i,_i,_j) = TNTable(i,_j) / CalcTN(_i,_j,TTIs(i))
    End If
  Next i
End
# ---------------------------------------------------------------------------------------
N_OnOff(N,p,x,mode)
#mode 1: BinomQx(N,P,x)
#quantile function of binomial distribution
#mode 2: quantile of weighted binomial distribution
CalcTN(_i,_j,_TTIMax)
#uses: Capacity_kbps
#  TTI_ms
#  PacketSize_bit
#  Activity
#  Delay
#  LossNDD
```

1. A method for controlling admission of a new connection onto a transport link in a communication network, said method comprising the steps of:
checking whether a multi-service-class traffic mix defined by previously admitted connections present on said link together with said new connection is contained within an overload-limited admissible region defined as a non-linear admissible region that contains a set of traffic mixes that fulfil a given overload requirement, where the dimensions of said non-linear admissible region are the number of connections in the respective service classes;
checking, for each of a number of said service classes, whether said traffic mix is contained also within a class-specific delay-limited admissible region approximated as a linear admissible region that contains a set of traffic mixes that fulfil a given class-specific delay requirement, where the dimensions of said linear admissible region are the number of connections in the respective service classes; and
admitting said new connection for transport over said transport link only if said traffic mix is contained within an intersection of said non-linear overload-limited admissible region and said linear delay-limited admissible region(s).

2. The method according to claim 1, wherein said delay-limited region is approximated as a linear region for a multi-service-class traffic mix generally modeled as a superposition of periodic on-off connections.

3. The method according to claim 1, wherein said overload-limited admissible region contains the set of traffic mixes for which the probability of temporarily overloading a queuing system associated with the transport link is smaller than a given target value.

4. The method according to claim 1, wherein said step of checking whether said traffic mix is contained within said non-linear overload-limited admissible region is representative of checking whether or not said traffic mix violates a delay requirement related to packet loss caused by temporary overload of said transport link.

5. The method according to claim 1, wherein said step of checking whether said traffic mix is contained within said non-linear overload-limited admissible region comprises the step of evaluating the following inequalities:
$${\sum }_{i = 1}^{K} {A}_{i} {ρ}_{i} \leq C ,$$
where K is the number of service classes in said traffic mix, Aᵢ is a per-class limit on the number of simultaneously active connections, ρᵢ is the average load generated by one active traffic source from class-i and C is the capacity of said transport link.

6. The method according to claim 5, wherein the per-class limit Aᵢ is the number of connections from class-i such that the probability that more than Aᵢ connections from class-i are active at the same time is smaller than a given target value.

7. The method according to claim 6, further comprising the steps of:
pre-calculating at least some of said Aᵢ values for a range of different values of the number Nᵢ of connections from class-i or for a range of different activity factors αᵢ;
storing said pre-calculated Aᵢ values in memory; and
accessing said pre-calculated Aᵢ values from said memory for on-line evaluation of said inequalities.

8. The method according to claim 6, further comprising the step of determining Aᵢ values by class-wise overload probability evaluation.

9. The method according to claim 8, wherein said step of determining Aᵢ values comprises the step of finding values of Aᵢ such that the following sets of inequalities:
$$\sqrt[{K}_{a}]{1 - {\tilde{ɛ}}_{i}^{lost}} \geq \frac{{\sum }_{{n}_{i} = 0}^{{A}_{i}} {n}_{i} {\prod }_{i} ( {n}_{i} )}{{N}_{i} {α}_{i}} , \sqrt[{K}_{a}]{1 - {\tilde{ɛ}}_{i}^{lost}} \geq {\sum }_{{n}_{l} = 0}^{{A}_{l}} {\prod }_{l} ( {n}_{l} )$$
$$l = 1 , 2 , … , {K}_{a} , l \neq i ,$$
are fulfilled, where K_{α} is the number of classes with activity factor αᵢ<1, \tilde{ε}ᵢ^{lost} is the target packet loss probability for service class-i approximated by the target overload probability assigned to class-i, Nᵢ is the number of connections from class-i and nᵢ is the number of actually active connections from class-i.

10. The method according to claim 1, wherein said class-specific packet delay requirement requires that the probability of the class-specific packet delay being larger than a given class-specific maximum delay is smaller than a given target value.

11. The method according to claim 1, comprising the step of checking whether said traffic mix is contained within multiple class-specific, delay-limited admissible regions by evaluating the following inequalities:
$${\sum }_{i = 1}^{K} {N}_{i} \cdot {TE}_{ij} \leq {TN}_{jj} + constant , j = 1 , 2 , … , K ,$$
where K is the number of service classes in said traffic mix, TNᵢⱼ is a representation of the maximum number of connections from class-i assuming that a packet from class-j would fulfil a packet delay requirement of class-j, TEᵢⱼ is a service class equivalent measure representing how many new connections can be admitted from class-j in place of a connection from class-i considering only the packet delay requirement of class-j and Nᵢ is the number of connections from class-i in the traffic mix.

12. The method according to claim 11, wherein TEᵢⱼ is calculated in the following way:
TEᵢⱼ=TNⱼⱼ/TNᵢⱼ, and
TNᵢⱼ is calculated in the following way:
$${TN}_{ij} = max \{ {N}_{i} \vert {\sum }_{{n}_{i} = 0}^{{N}_{i}} \prod ( {n}_{i} ) Pr ( {D}_{j}^{( i )} > {\tilde{D}}_{j} \vert {n}_{i} connections are active ) \leq {\tilde{ɛ}}_{j}^{delayed} \} ,$$
where Dⱼ⁽ⁱ⁾ denotes the delay of a packet from class-j assuming that the delay of the associated queue comes from only class-i connections, \tilde{D}ⱼ is the target delay criteria of packets from class-j, Pr(Dⱼ⁽ⁱ⁾>\tilde{D}ⱼ|nᵢ connections are active) is the probability of packet delay criteria violation, \tilde{ε}ⱼ^{delayed} is the target value for the probability of a packet exceeding its delay criteria without getting lost and nᵢ is the number of actually active connections from class-i.

13. The method according to claim 12, wherein the probability of packet delay criteria violation Pr(Dⱼ⁽ⁱ⁾>\tilde{D}ⱼ|nᵢ connections are active) is calculated in the following way:
$$Pr ( {D}_{j}^{( i )} > {\tilde{D}}_{j} \vert {n}_{i} connections are active ) = {\sum }_{{x}^{′} < l \leq {n}_{i}} ( \begin{matrix}{n}_{i} \\ l\end{matrix} ) {( \frac{l - {x}^{′}}{{TTI}^{′}} )}^{l} {( 1 - \frac{l - {x}^{′}}{{TTI}^{′}} )}^{{n}_{i} - l} \cdot \frac{{TTI}^{′} - {n}_{i} + {x}^{′}}{{TTI}^{′} - l + {x}^{′}} \\ {x}^{′} = ( {\tilde{D}}_{j} - \frac{{b}_{j}}{C} ) / TU \\ {TTI}^{′} = {TTI}_{i} / TU \\ TU = \frac{{b}_{i}}{C} ,$$
where bⱼ is the class-j packet size, C is the capacity of said transport link and TTIᵢ is the relevant packet inter-arrival time.

14. The method according to claim 12, wherein the probability of packet delay criteria violation Pr(Dⱼ⁽ⁱ⁾>\tilde{D}ⱼ|nᵢ connections are active) is calculated in the following way:
$$Pr ( {D}_{j}^{( i )} > {\tilde{D}}_{j} \vert {n}_{i} connections are active ) = exp \{ - \frac{2 Cx}{{TTI}_{i} {n}_{i} {ρ}_{i}^{2}} ( \frac{Cx}{{TTI}_{i}} + C - {n}_{i} {ρ}_{i} ) \}$$
$$x = {\tilde{D}}_{j} - \frac{{b}_{j}}{C} ,$$
where C is the capacity of said transport link, TTIᵢ is the relevant packet inter-arrival time, by is the class-j packet size and ρᵢ is the average load generated by one active traffic source from class-i.

15. The method according to claim 11, wherein TEᵢⱼ is defined as TEᵢⱼ=TNⱼⱼ/TNᵢⱼ, and TNᵢⱼ is calculated in the following way:
$${TN}_{ij} = ⌈ \frac{C + \frac{Cx {α}_{i}}{{TTI}_{i}}}{{α}_{i} {ρ}_{i} - \frac{{α}_{i} {ρ}_{i}^{2} {TTI}_{i} ln ( {\tilde{ɛ}}_{j}^{delayed} )}{2 x}} ⌉$$
$$x = {\tilde{D}}_{j} - \frac{{b}_{j}}{C} ,$$
where C is the capacity of said transport link, αᵢ is the activity factor of class-i, TTIᵢ is the relevant packet inter-arrival time, ρᵢ is the average load generated by one active traffic source from class-i, bⱼ is the class-j packet size and \tilde{ε}ⱼ^{delayed} is the target value for the probability of a packet exceeding its delay criteria without getting lost.

16. The method according to claim 11, further comprising the step of updating TNᵢⱼ and TEᵢⱼ, before said step of checking whether said traffic mix is contained within said intersection of admissible regions, only when said new connection belongs to a new service class.

17. The method according to claim 11, further comprising the step of assigning TNᵢⱼ a real value by means of interpolation.

18. The method according to claim 12, wherein, if class-i packets have higher priority than class-j packets, the probability of packet delay criteria violation is calculated in the following way:
$$Pr ( {B}^{( i )} ( 0 , {\tilde{D}}_{j} - \frac{{s}_{last}}{C} ) < \frac{{b}_{j} - {s}_{last}}{C} ) ,$$
where B⁽ⁱ⁾(0, t) denotes the server availability in [0, t] seen by the class-j packet arriving at time 0, sₗₐₛₜ denotes the size of the last segment of the class-j packet, and bⱼ is the class-j packet size.

19. The method according to claim 1, wherein said communication network is a transport network based on the Universal Terrestrial Radio Access Network (UTRAN).

20. A method for controlling admission of a new connection onto a transport link in a communication network, said method comprising the steps of:
checking whether a multi-service traffic mix defined by previously admitted connections present on said link together with said new connection is contained within a non-linear overload-limited admissible region by evaluating the following inequalities:
$${\sum }_{i = 1}^{K} {A}_{i} {ρ}_{i} \leq C ,$$
where K is the number of service classes in said traffic mix, Aᵢ is a per-class limit on the number of simultaneously active connections, ρᵢ is the average load generated by one active traffic source from class-i and C is the capacity of said transport link; and
admitting said new connection for transport over said transport link only if said traffic mix is contained within said non-linear overload-limited admissible region.

21. A method for controlling admission of a new connection onto a transport link in a communication network, said method comprising the steps of:
checking whether a multi-service traffic mix defined by previously admitted connections present on said link together with said new connection is contained within an intersection of multiple service-class-specific delay-limited admissible regions by evaluating the following inequalities:
$${\sum }_{i = 1}^{K} {N}_{i} \cdot {TE}_{ij} \leq {TN}_{jj} + constant , j = 1 , 2 , … , K ,$$
where K is the number of service classes in said traffic mix, TNᵢⱼ is a representation of the maximum number of connections from class-i assuming that a packet from class-j would fulfil a packet delay requirement of class-j, TEᵢⱼ is a service class equivalent measure representing how many new connections can be admitted from class-j in place of a connection from class-i considering only the packet delay requirement of class-j and Nᵢ is the number of connections from class-i in the traffic mix; and
admitting said new connection for transport over said transport link only if said traffic mix is contained within said intersection of admissible regions.

22. An admission controller for controlling admission of a new connection onto a transport link in a communication network, said admission controller comprising:
means for checking whether a multi-service-class traffic mix defined by previously admitted connections present on said link together with said new connection is contained within an overload-limited admissible region defined as a non-linear admissible region that contains a set of traffic mixes that fulfil a given overload requirement, where the dimensions of said non-linear admissible region are the number of connections in the respective service classes;
means for checking, for each of a number of said service classes, whether said traffic mix is contained also within a class-specific delay-limited admissible region approximated as a linear admissible region that contains a set of traffic mixes that fulfil a given class-specific delay requirement, where the dimensions of said linear admissible region are the number of connections in the respective service classes; and
means for admitting said new connection for transport over said transport link only if said traffic mix is contained within an intersection of said non-linear overload-limited admissible region and said linear delay-limited admissible region(s).

23. The admission controller according to claim 22, wherein said delay-limited region is approximated as a linear region for a multi-service-class traffic mix generally modeled as a superposition of periodic on-off connections.

24. The admission controller according to claim 22, wherein said overload-limited admissible region contains the set of traffic mixes for which the probability of temporarily overloading a queuing system associated with the transport link is smaller than a given target value.

25. The admission controller according to claim 22, wherein said means for checking whether said traffic mix is contained within said non-linear overload-limited admissible region is operable for checking whether said traffic mix violates a packet delay requirement related to packet loss caused by temporary overload of said transport link.

26. The admission controller according to claim 22, wherein said means for checking whether said traffic mix is contained within said non-linear overload-limited admissible region comprises means for evaluating the following inequalities:
$${\sum }_{i = 1}^{K} {A}_{i} {ρ}_{i} \leq C ,$$
where K is the number of service classes in said traffic mix, Aᵢ is a per-class limit on the number of simultaneously active connections, ρᵢ is the average load generated by one active traffic source from class-i and C is the capacity of said transport link.

27. The admission controller according to claim 26, wherein the per-class limit Aᵢ is the number of connections from class-i such that the probability that more than Aᵢ connections from class-i are active at the same time is smaller than a given target value.

28. The admission controller according to claim 27, further comprising:
means for pre-calculating at least some of said Aᵢ values for a range of different values of the number Nᵢ of connections from class-i or for a range of different activity factors αᵢ;
means for storing said pre-calculated Aᵢ values in memory; and
means for accessing said pre-calculated Ai values from said memory for on-line evaluation of said inequalities.

29. The admission controller according to claim 27, further comprising means for determining Aᵢ values by class-wise overload probability evaluation.

30. The admission controller according to claim 29, wherein said means for determining Aᵢ values comprises means for finding values of Aᵢ such that the following sets of inequalities:
$$\begin{matrix}\sqrt[{K}_{a}]{1 - {\tilde{ɛ}}_{i}^{lost}} \geq \frac{{\sum }_{{n}_{i} = 0}^{{A}_{i}} {n}_{i} {\prod }_{i} ( {n}_{i} )}{{N}_{i} {α}_{i}} , \\ \begin{matrix}\sqrt[{K}_{a}]{1 - {\tilde{ɛ}}_{i}^{lost}} \geq {\sum }_{{n}_{l} = 0}^{{A}_{l}} {\prod }_{l} ( {n}_{l} ) & & & l = 1 , 2 , … , {K}_{a} , l \neq i ,\end{matrix}\end{matrix}$$
are fulfilled, where K_{α} is the number of service classes with activity factor αᵢ<1, \tilde{ε}ᵢ^{lost} is the target packet loss probability for service class-i approximated by the target overload probability assigned to class-i, Nᵢ is the number of connections from class-i and nᵢ is the number of actually active connections from class-i.

31. The admission controller according to claim 22, wherein said class-specific packet delay requirement requires that the probability of the class-specific packet delay being larger than a given class-specific maximum delay is smaller than a given target value.

32. The admission controller according to claim 22, comprising means for checking whether said traffic mix is contained within multiple class-specific, delay-limited admissible regions based on evaluation of the following inequalities:
$${\sum }_{i = 1}^{K} {N}_{i} \cdot {TE}_{ij} \leq {TN}_{jj} + constant , \qquad j = 1 , 2 , … , K ,$$
where K is the number of service classes in said traffic mix, TNᵢⱼ is a representation of the maximum number of connections from class-i assuming that a packet from class-j would fulfil a packet delay requirement of class-j, TEᵢⱼ is a service class equivalent measure representing how many new connections can be admitted from class-j in place of a connection from class-i considering only the packet delay requirement of class-j and Nᵢ is the number of connections from class-i in the traffic mix.

33. The admission controller according to claim 32, wherein said means for checking whether said traffic mix is contained within multiple class-specific, delay-limited admissible regions comprises:
means for calculating TEᵢⱼ in the following way:
TEᵢⱼ=TNⱼⱼ/TNᵢⱼ; and
means for calculating TNᵢⱼ in the following way:
$${TN}_{ij} = max \{ {N}_{i} \vert {\sum }_{{n}_{i} = 0}^{{N}_{i}} Π ( {n}_{i} ) Pr ( {D}_{j}^{( i )} > {\tilde{D}}_{j} \vert {n}_{i} connections are active ) \leq {\tilde{ɛ}}_{j}^{delayed} \} ,$$
where Dⱼ⁽ⁱ⁾ denotes the delay of a packet from class-j assuming that the delay of the associated queue comes from only class-i connections, \tilde{D}ⱼ is the target delay criteria of packets from class-j, Pr(Dⱼ⁽ⁱ⁾>\tilde{D}ⱼ|nᵢ connections are active) is the probability of packet delay criteria violation, \tilde{ε}ⱼ^{delayed} is the target value for the probability of a packet exceeding its delay criteria without getting lost and nᵢ is the number of actually active connections from class-i.

34. The admission controller according to claim 33, wherein said means for calculating TNᵢⱼ comprises means for calculating the probability of packet delay criteria violation Pr(Dⱼ⁽ⁱ⁾>\tilde{D}ⱼ|nᵢ connections are active) in the following way:
$$Pr ( {D}_{j}^{( i )} > {\tilde{D}}_{j} \vert {n}_{i} connections are active ) = {\sum }_{{x}^{′} < l \leq {n}_{i}} ( \begin{matrix}{n}_{i} \\ l\end{matrix} ) {( \frac{l - {x}^{′}}{{TTI}^{′}} )}^{l} {( 1 - \frac{l - {x}^{′}}{{TTI}^{′}} )}^{{n}_{i} - l} \cdot \frac{{TTI}^{′} - {n}_{i} + {x}^{′}}{{TTI}^{′} - l + {x}^{′}}$$
$${x}^{′} = ( {\tilde{D}}_{j} - \frac{{b}_{j}}{C} ) / TU$$
$${TTI}^{′} = {TTI}_{i} / TU$$
$$TU = \frac{{b}_{i}}{C} ,$$
where bⱼ is the class-j packet size, C is the capacity of said transport link and TTIᵢ is the relevant packet inter-arrival time.

35. The admission controller according to claim 33, wherein said means for calculating TNᵢⱼ comprises means for calculating the probability of packet delay criteria violation Pr(Dⱼ⁽ⁱ⁾>\tilde{D}ⱼ|nᵢ connections are active) in the following way:
$$Pr ( {D}_{j}^{( i )} > {\tilde{D}}_{j} \vert {n}_{i} connections are active ) = exp \{ - \frac{2 C x}{{TTI}_{i} {n}_{i} {ρ}_{i}^{2}} ( \frac{C x}{{TTI}_{i}} + C - {n}_{i} {ρ}_{i} ) \}$$
$$x = {\tilde{D}}_{j} - \frac{{b}_{j}}{C} ,$$
where C is the capacity of said transport link, TTIᵢ is the relevant packet inter-arrival time, bⱼ is the classy packet size and ρᵢ is the average load generated by one active traffic source from class-i.

36. The admission controller according to claim 32, wherein said means for checking whether said traffic mix is contained also within multiple class-specific, delay-limited admissible regions comprises:
means for calculating TEᵢⱼ in the following way:
TEᵢⱼ=TNⱼⱼ/TNᵢⱼ; and
means for calculating TNᵢⱼ in the following way:
$$\begin{matrix}{TN}_{ij} = ⌈ \frac{C + \frac{C x {α}_{i}}{{TTI}_{i}}}{{α}_{i} {ρ}_{i} - \frac{{α}_{i} {ρ}_{i}^{2} {TTI}_{i} ln ( {\tilde{ɛ}}_{j}^{delayed} )}{2 x}} ⌉ \\ x = {\tilde{D}}_{j} - \frac{{b}_{j}}{C} ,\end{matrix}$$
where C is the capacity of said transport link, αᵢ is the activity factor of class-i, TTIᵢ is the relevant packet inter-arrival time, ρᵢ is the average load generated by one active traffic source from class-i, bⱼ is the class-j packet size and \tilde{ε}ⱼ^{delayed} is the target value for the probability of a packet exceeding its delay criteria without getting lost.

37. The admission controller according to claim 32, further comprising means for updating TNᵢⱼ and TEᵢⱼ, before checking whether said traffic mix is contained within said intersection of admissible regions, when said new connection belongs to a new service class.

38. The admission controller according to claim 32, further comprising means for assigning TNᵢⱼ a real value by means of interpolation.

39. The admission controller according to claim 33, wherein, if class-i packets have higher priority than class-j packets, the probability of packet delay criteria violation is calculated in the following way:
$$Pr ( {B}^{( i )} ( 0 , {\tilde{D}}_{j} - \frac{{s}_{last}}{C} ) < \frac{{b}_{j} - {s}_{last}}{C} ) ,$$
where B⁽ⁱ⁾(0, t) denotes the server availability in [0, t] seen by the class-j packet arriving at time 0, sₗₐₛₜ a denotes the size of the last segment of the class-j packet, and bⱼ is the class-j packet size.

40. The admission controller according to claim 22, wherein said communication network is a transport network based on the Universal Terrestrial Radio Access Network (UTRAN).

41. An admission controller for controlling admission of a new connection onto a transport link in a communication network, said admission controller comprising:
means for checking whether a multi-service traffic mix defined by previously admitted connections present on said link together with said new connection is contained within a non-linear overload-limited admissible region based on evaluation of the following inequalities:
$${\sum }_{i = 1}^{K} {A}_{i} {ρ}_{i} \leq C ,$$
where K is the number of service classes in said traffic mix, Aᵢ is a per-class limit on the number of simultaneously active connections, ρᵢ is the average load generated by one active traffic source from class-i and C is the capacity of said transport link; and
means for admitting said new connection for transport over said transport link only if said traffic mix is contained within said non-linear overload-limited admissible region.

42. An admission controller for controlling admission of a new connection onto a transport link in a communication network, said admission controller comprising:
means for checking whether a multi-service traffic mix defined by previously admitted connections present on said link together with said new connection is contained within an intersection of multiple service-class-specific delay-limited admissible regions based on evaluation of the following inequalities:
$${\sum }_{i = 1}^{K} {N}_{i} \cdot {TE}_{ij} \leq {TN}_{jj} + constant , \qquad j = 1 , 2 , … , K ,$$
where K is the number of service classes in said traffic mix, TNᵢⱼ is a representation of the maximum number of connections from class-i assuming that a packet from class-j would fulfil a packet delay requirement of class-j, TEᵢⱼ is a service class equivalent measure representing how many new connections can be admitted from class-j in place of a connection from class-i considering only the packet delay requirement of class-j and Nᵢ is the number of connections from class-i in the traffic mix; and
means for admitting said new connection for transport over said transport link only if said traffic mix is contained within said intersection of admissible regions.
